(19) United States
(12) Patent Application Publication
(10) Pub. No.: US 2021/0152071 A1
(43) Pub. Date: May 20, 2021

(54) SUPERCONDUCTING BRUSHLESS COMMUNTATORLESS DC ELECTRICAL MOTOR AND GENERATOR

(71) Applicant: Emanuel E. Shah, Austin, TX (US)

(72) Inventor: Emanuel E. Shah, Austin, TX (US)

(21) Appl. No.: 16/688,035

(22) Filed: Nov. 19, 2019

(51) Int. Cl. H02K 55/04; H02K 1/27; H02K 3/24

(52) U.S. Cl. CPC H02K 55/04; H02K 3/24; H02K 1/278

(57) ABSTRACT

A superconducting brushless communtatorless DC electrical motor and generator includes a machine housing, a first stationary member, a first rotating member, a second stationary member, a second rotating member, a shaft, a power transfer device and a cooling assembly. The superconducting brushless communtatorless DC electrical motor and generator produces a magnetic field where at least one coil side produces main driving torque and the remaining coil sides produce torque that cancels torque produced by the remaining coil sides in a direction opposite the main driving torque. This prevents the remainder of the coil sides to produce torque in the direction opposite the main driving torque and producing continue rotation.

### BACKGROUND

### 1. Field of the Invention

The present invention relates generally to electrical machine systems, and more specifically, to a superconducting brushless communtatorless DC electrical motor and generator system.

### 2. Description of Related Art

Electrical machine systems are well known in the art with different types of brushless and brush type machines with different definitions of construction and performance.

Superconducting field coils with conventional copper stator has been the norm for the industry since the superconducting technology has been available. This topology offers great performance and other advantages over conventional machines but with several limitations. This topology offers the air gap sheer stress in the range between 30 psi and 100 psi. When superconducting windings are used in both stator and rotor the current values are increased by a factor of 100 or more in rotor windings. This allows much higher airgap sheer stress along with higher magnetic loading achievable with fully cryogenic machine architecture. The direct result of this innovative architecture is higher power density and superior performance. The new innovative design allows the use of superconducting coils in both stator and rotor construction. This also eliminates AC losses in the two windings. This will result in increased power density, superior performance and lower cost not achievable with existing superconducting machines with copper stator coils.

Another important feature of the new machine architecture is that the rotor conductors are active during the entire 360 degrees of rotation. The DC architecture of the machine also allows high torque density. Depending upon the type of motor design these two important features are not possible in existing motor designs. One skilled in the art can understand this problem. The direct result of this is further increase in power and torque density and further reduction in cost.

Accordingly, although great strides have been made in the area of electrical machine systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1 and 1A shows a superconducting coil;

FIG. 2A shows a triangular coil;

FIGS. 2B and 2C shows a right-angled multisided coil;

FIGS. 3 and 3A shows a principle of motor action with rotor coil perpendicular to shaft and stator coil according to the present application;

FIGS. 4 and 4A shows the principle of motor action with rotor coil parallel to stator coil according to the present application;

FIGS. 5 and 5A shows the principle of motor action with rotor coil provided with right angle extension according to the present application;

FIGS. 6 and 6A shows a construction and integrated assembly of a superconducting motor with rotor coils perpendicular to a stator coil;

FIGS. 7 and 7A shows the construction and integrated assembly of the superconducting motor with rotor coils perpendicular to the stator coil with rotor coil parallel to stator coil;

FIGS. 8 and 8A shows the construction and integrated assembly of the superconducting motor with rotor coils with right angle extension;

FIG. 9 shows the connection scheme for separately excited motor using Liquid metal rotating contacts (LMRC);

FIG. 10 shows the connection scheme for separately excited motor using rotatable switch mode transformer (RSMT);

FIG. 11 shows the connection scheme for a DC shunt motor utilizing liquid metal rotating contacts (LMRC);

FIG. 12 shows the connection scheme for DC shunt motor using rotatable switch mode transformer (RSMT);

FIG. 13 shows the connection scheme for DC shunt motor using rotatable switch mode transformer (RSMT) where both the armature and the shunt field are provided with variable DC power;

FIG. 13A shows the connection scheme for DC shunt motor using LMRC;

FIG. 14 shows the connection scheme for DC shunt motor using AC transformer;

FIG. 15 shows the connection scheme for a DC series motor utilizing liquid metal rotating contacts (LMRC);

FIG. 16 shows the connection scheme for a DC series motor utilizing RSMT;

FIG. 17 shows the connection scheme for a DC compound motor utilizing LMRC;

FIG. 18 shows the connection schematic fora superconducting DC generator according to the present application;

FIGS. 19 and 19A shows the principle of generator action according to the present application;

FIGS. 20 and 20A show the construction and integrated assembly of a superconducting DC generator;

FIGS. 21, 21A and 21B show embodiments of coils;

FIG. 22 shows a triangular coil;

FIG. 23 shows a bifurcated coil is used in the rotating armature;

FIGS. 24 and 24A show the construction and integrated assembly of an iron core armature, permanent magnet motor with bifurcated armature coils perpendicular to the stator;

FIGS. 25 and 25A show the construction and integrated assembly of an iron core armature, wound stator motor with bifurcated armature coils perpendicular to the stator;

FIGS. 26 and 26A show a bifurcated coil is used in the rotating armature;

FIGS. 27 and 27A show the construction and integrated assembly of an iron core armature, cylindrical permanent magnet motor with bifurcated armature coils where shaft is parallel to the cylindrical stator;

FIGS. 28 and 28A show the construction and integrated assembly of an iron core armature, cylindrical wound stator motor with bifurcated armature coils perpendicular to the stator;

FIGS. 29 and 29A shows operating principles of linear motors;

FIG. 30 shows an embodiment of a linear motor where the plane of the armature coils is perpendicular to the stator coil;

FIGS. 31 and 31A shows the construction and integrated assembly of a superconducting DC linear motor;

FIG. 32 shows the construction and integrated assembly of an iron core armature, permanent magnet stator linear motor with triangular armature coils perpendicular to the stator;

FIGS. 33, 33A, 34, 34A, 34B and 34C describes the embodiments of a motor with two stator coils with poles of like polarity interacting with rotor coils.

FIGS. 35 and 35A show the principle of motor action plane of the rotor coil perpendicular to shaft and to stator coil according to the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional electrical machine systems. Specifically, the present application discloses an innovative magnetic field circuit generated by a single stator coil with special characteristics linking at least one rotor coil with special characteristics through airgaps. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

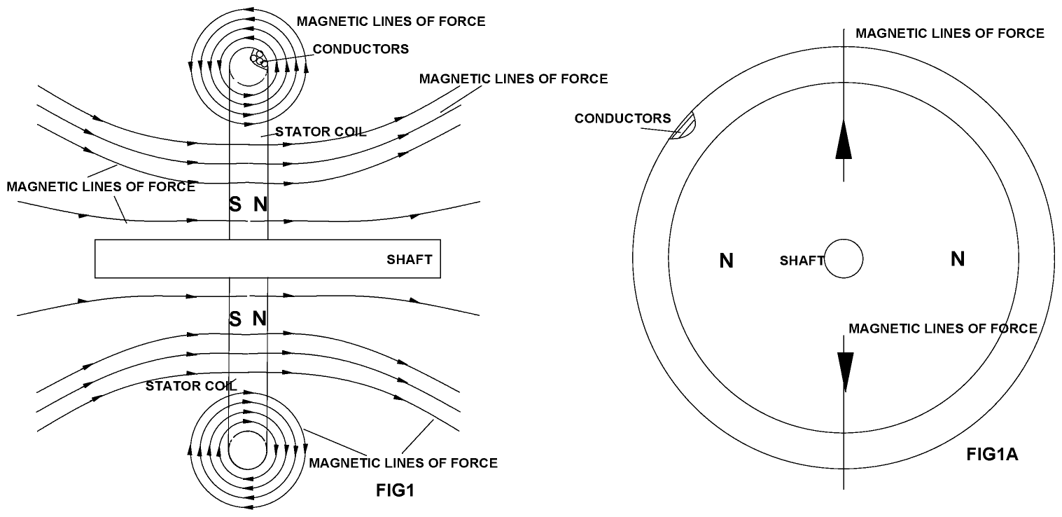

Referring now to the drawings wherein like reference characters identify corresponding or similar elements throughout the several views, FIG. 1 depicts a superconducting coil of a superconducting brushless communtatorless DC electrical motor and generator system in accordance with a preferred embodiment of the present application. It will be appreciated that the system overcomes one or more of the above-listed problems commonly associated with conventional electrical machine systems.

### DC Superconducting Reversible Motor and Generator Electrical Machine

In the contemplated embodiment, FIG. 1 shows a superconducting coil 1 which may be used for both motor action and generator action. The coil 1 is wound with superconducting wires and when excited by a DC current the coil 1 may generate a magnetic field as shown in FIG. 1. Magnetic lines of force may originate from the North Pole and return to the South Pole as shown in FIG. 1.

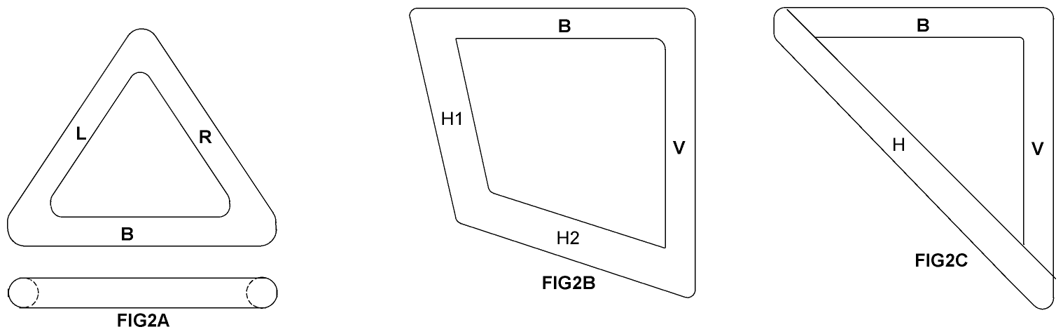

FIG. 2A shows a triangular coil and FIGS. 2B and 2C show right angled multisided coils. These two superconducting coils may be used for both motor action and generator action. FIG. 2A shows a triangle coil with coil sides B, L and R denoting three sides of the coil.

FIGS. 2B and 2C show right angled multisided coil with coil sides B, V and two sections H1 and H2 formed by bending the sections H1 and H2 at right angle to the plane of coil sides B and V.

Although the description may describe two main coil types, it should be appreciated that it may be possible to design different coil types based on the principles of the present application. The primary design goal of the coil is to generate torque by using the coil sides that rotate a shaft and cancel torques produced by the coil sides that oppose the torque on the shaft.

Operating Principles of Superconducting Dc Motor with Rotor Coils Perpendicular to the Stator Coil

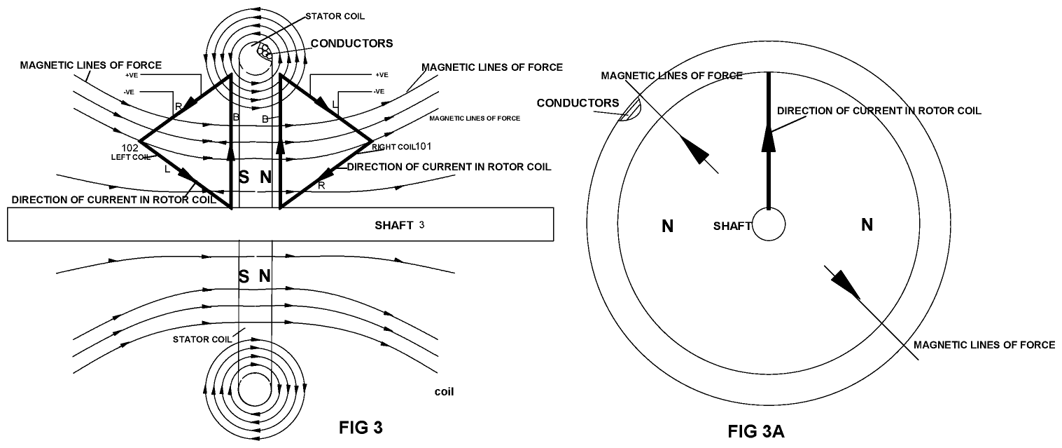

FIGS. 3 and 3A show a principle of motor action according to the present application. For the motor action the term stator and field and rotor and armature are used interchangeably. A stationary stator coil 2 may generate a magnetic field as shown in FIGS. 3 and 3A.

A rotating shaft 3 may be assembled as shown in FIGS. 3 and 3A. Tow coils 101 and 102 as shown in FIG. 2A with sides B, L and R are mounted on the shaft as shown in FIGS. 3 and 3A. Only two coils are shown to describe the principle of operation, but in actual practice a large number of coils may be assembled to meet desired specifications. These coils link the magnetic field generated by the stator coil 2.

When the rotor coils 101 and 102 are supplied with DC current and with the direction of current as shown in FIGS. 3 and 3A the following actions take place.

Applying Fleming's left hand rule of the motor action to sides B of the coils 101 and 102 which are perpendicular to the shaft 3, it will be observed that this action will cause the shaft 3 to rotate when forces are generated on the coil sides B. The coil sides L and R of coils 101 and 102 will tend to rotate the shaft 3 depending on the direction of current in each coil side and the direction of the magnetic field which links these sides. The direction of torque produced by each coil side may be determined by the Fleming's left hand rule of motor action and this action may produce a final rotational effect on the rotation of the shaft 3.

Observing coils 101 and 102 from right to left towards the center of the shaft 3, the direction of current in the coils 101 and 102 may be as shown in FIGS. 3 and 3A. Applying the Fleming's left hand rule of motor action, the coil side L of coil 101 may generate the rotation of the coil in anticlockwise direction and simultaneously the coil side R of coil 102 may generate rotation of the coil in clockwise direction. These two rotational forces may cancel each other causing the net rotational force exerted on the shaft to be zero.

In a similar manner Applying the Fleming's left hand rule of motor action to the coil side R of coil 101 may generate a rotation of the coil in clockwise direction while simultaneously the coil side L of coil 102 may generate rotation of the coil in anticlockwise direction. These two rotational forces may cancel each other causing the net rotational force exerted on the shaft to be zero.

It may be observed that the rotational torque produced by coil sides L and R of coils 101 and 102 may cancel each other and the resultant torque produced by coils 101 and 102 may be the torque produced by the coil sides B of coils 101 and 102.

Selecting a flux density generated by stator coil 3 and the number of turns of stator and rotor coils and dimensions of sides B, the motor may be able to produce desired values of torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art. These design concepts and fully cryogenic refrigeration may produce double the power density and thus power output of a motor of similar size available in the prior art.

Construction and Assembly of Superconducting Dc Motor with Rotor Coils Perpendicular to the Stator Coil

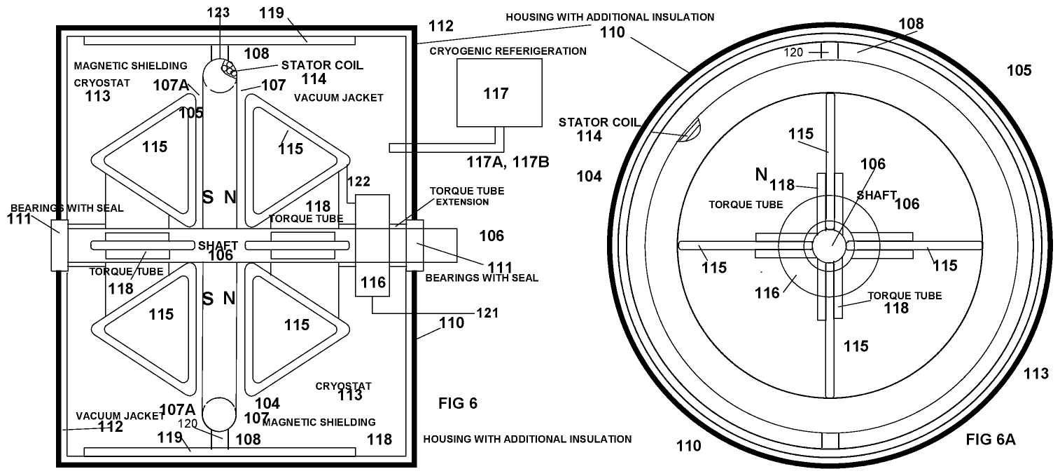

FIGS. 6 and 6A show a construction and integrated assembly of a superconducting motor with rotor coils perpendicular to a stator coil.

The motor includes a stator assembly 104 and a rotor assembly 105. The rotor assembly 105 is mounted on a rotating shaft 106 and the rotor assembly rotates as it magnetically links the stator assembly 104 by airgaps 107 and 107A. The magnetic field produced by one pole of the stator coil may be returned to the other pole by flux return path 108. The stator assembly may be supported by stator supports 109. Both the stator assembly 104 and rotor assembly 105 are mounted inside a motor housing 110. The rotating shaft 106 may be located on the housing by two bearings 111 as shown in FIGS. 6 and 6A. The bearings may be either insulted from the housing or designed to operate in cryogenic environment. A vacuum jacket 112 with extra insulation creates a structure within the housing 110. The stator assembly 104 and rotor assembly 105 may be mounted inside. This structure may be defined as low temperature cryostat 113. The function of the cryostat 113 is to maintain superconducting temperatures for the stator coil 114 and rotor coils 115 to maintain superconducting properties to conduct superconducting currents and maintain flux. Both the stator coil 114 and rotor coils 115 may be wound with HTS 2G superconducting wires. This may allow motor operation be 77K.

Installed on the shaft 106 is a rotor power unit (RPU) 116. The RPU 116 has a rotating member and a stationary member. The stationary member is mounted on the housing 110 and the rotating member is mounted on the shaft 106. DC or AC power may be applied to the stationary member of the RPU 116 and electrical power may be transferred to the rotating member electromagnetically. The output of the rotating member may be connected to the rotor coils 115. The rotor coils 115 may be connected in series or parallel to the output of the RPU 116 to obtain a desired result.

Since high air gap sheer stresses may be generated this may result in high mechanical forces on the rotor coils 115. Therefore, it may be important to wind the rotor coils 115 in a high strength coil former made from high strength suitable material and impregnated with epoxy resins. The input to the rotor coils may be DC.

A closed loop cryogenic refrigeration system 117 as shown in FIGS. 6 and 6A may be located outside the motor housing and connected to the cryostat by refrigerant transfer tube 117A and return tube 117B as shown in FIGS. 6 and 6A. The cryogenic refrigeration system 117 conducts heat from the rotor coils 115 and stator coil 114 to the cryogenic refrigeration system 117, where the heat is dissipated. Cryogenic refrigeration system 117 maintains superconducting temperatures inside the cryostat 113 by circulating cryogenic refrigerant at superconducting temperatures. This keeps the stator coil 114 and rotor coils 115 in the superconducting state.

The rotor coils 115 are connected to the rotor shaft 106 by a torque tube 118 and the outer surface of the torque tube 118 may form the support structures for the rotor coils 115. The function of torque tube 118 is to transfer the torque produced by the rotor coils 115 to the shaft 106. The torque tube 118 also acts as a heat shield between the cryostat and the shaft 106 exposed to outside warm temperatures. This reduces the thermal load on cryogenic refrigeration system. The separate sections of the shaft 106 where coil is not mounted contains torque tube extensions 118A which also insulates cryostat from the sections of shaft 106 exposed to warm temperatures.

An electromagnetic shield 119 may be fabricated around the stator assembly 114 and attached to vacuum jacket 112. The stator assembly 114 may be secured to the housing by stator supports 120.

Under the description of operating principles for rotor coils 115 perpendiculars to the stator coil 114 is described in detail how different electromagnetic mechanisms generate the required torque for the rotor coils 115.

For the motor operation to take place, the rotor coils 115 may have to connect to the stator coil 114 and the stator coil 114 powered from PSS and rotor coils 115 powered from RPU 116.

Operating Principles of Superconducting Dc Motor with Rotor Coils Parallel to the Stator Coil

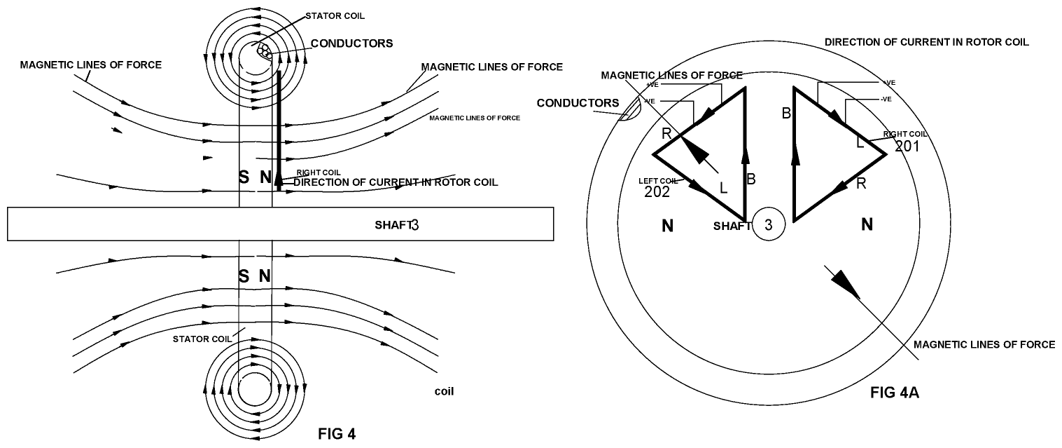

FIGS. 4 and 4A shows the principle of motor action according to the present application. A stationary stator coil 2 may generate a magnetic field as shown in FIGS. 4 and 4A.

A rotating shaft 3 may be assembled as shown in FIGS. 4 and 4A. Two coils 201 and 202 as shown in FIG. 2A with sides B, L and R may be mounted on the shaft as shown in FIGS. 4 and 4A. Only two coils are shown to describe the principle of operation, but in actual practice a large number of coils may be assembled to meet a desired specification. These coils link the magnetic field generated by the stator coil 2.

When the rotor coils 201 and 202 are supplied with DC current and with the direction of current as shown in FIGS. 4 and 4A the following actions take place.

Applying Fleming's left hand rule of the motor action to sides B of the coils 201 and 202 which are perpendicular to the shaft 3 it may be observed that his action causes the shaft to rotate when forces are generated on the coil sides B. The coil sides L and R of coils 201 and 202 may rotate the coil and not the shaft depending on the direction of current in each coil side and the direction of the magnetic field linked by these sides. The direction of torque produced by each coil side may be determined by the Fleming's left hand rule of motor action and this action may produce final rotational effect on the rotation of the shaft 3.

Looking at coils 201 and 202 from right to left towards the center of the shaft 3 the direction of current in the coils 201 and 202 may be as shown in FIGS. 4 and 4A. Applying Fleming's left hand rule of motor action, the coil side L of coil 201 may generate the rotation of the coil in clockwise direction while simultaneously the coil side R of coil 201 may generate the rotation of the coil in anticlockwise direction. These two rotational forces may cancel each other and produce a net rotational force exerted on the shaft of zero.

In a similar manner, Applying the Fleming's left hand rule of motor action to the coil side R of coil 202 may generate the rotation of the coil in clockwise direction while simultaneously the coil side L of coil 202 may generate the rotation of the coil in anticlockwise direction. These two rotational forces may cancel each other and produce a net rotational force exerted on the shaft of zero.

It may be observed that the rotational force produced on coil sides L and R of coils 201 and 202 may cancel each other ant eh resultant torque produced by coils 201 and 202 may be the torque produced by the coil sides B of coils 201 and 202.

Selecting a flux density generated by stator coil 3 and the number of turns of stator and rotor coils and dimensions of the sides B, the motor may be able to produce desired values of torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art superconducting motors and generators. These design concepts and fully cryogenic refrigeration may produce more than double the power density and thus power output of a motor of similar size available in the prior art superconducting motors and generators.

Construction and Assembly of Superconducting Dc Motor with Rotor Coils Parallel to the Stator Coil

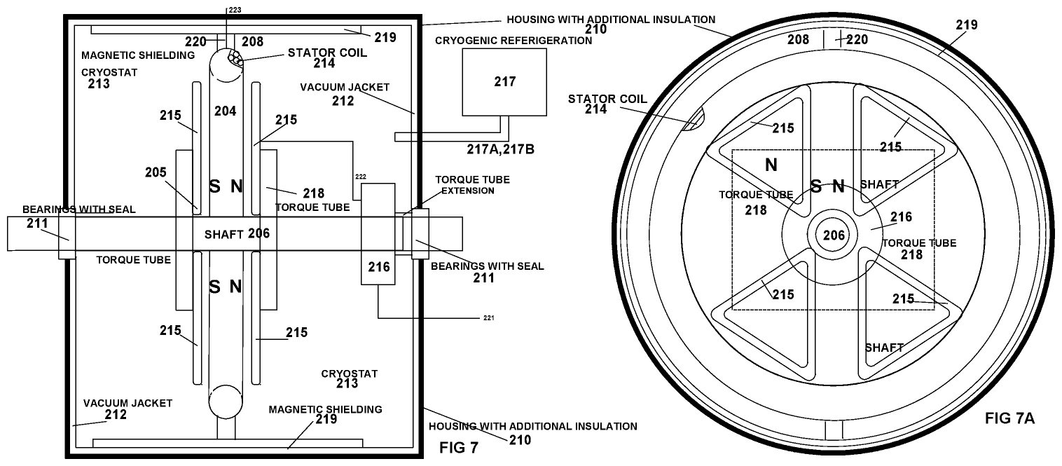

FIGS. 7 and 7A show the construction and integrated assembly of a superconducting motor and rotor coils parallel to the stator coil.

The motor includes a stator assembly 204 and a rotor assembly 205. The rotor assembly 205 may be mounted on a rotating shaft 206 and the rotor assembly rotates as it magnetically links the stator assembly 204 by airgaps 207 and 207A. The magnetic field produced by one pole of the stator coil may return to the other pole by flux return path 208. The stator assembly may be supported by stator supports 209. Both the stator and rotor assemblies may be mounted inside a motor housing 210. The rotating shaft 206 may be located on the housing by two bearings 211 as shown in FIGS. 7 and 7A. A vacuum jacket 212 with extra insulation creates a structure within the housing 210. The stator assembly 204 and rotor assembly 205 may be mounted in side this structure. This structure may be defined as low temperature cryostat 213. The function of the cryostat 213 is to maintain superconducting temperatures for the stator coil 214 and rotor coils 215 to maintain superconducting properties to conduct superconducting currents and maintain flux. Both the stator coil 214 and rotor coils 215 are preferably wound with HTS 2G superconducting wires. This may allow motor operation below 77K.

A rotor power unit (RPU) 216 may be installed on the shaft 206. The RPU 216 may have a rotating member and a stationary member. The stationary member may be mounted on the housing 210 and the rotating member may be mounted on the shaft 206. DC or AC power may be applied to the stationary member of the RPU 216 and electrical power transferred to the rotating member electromagnetically. The output of the rotating member may be connected to the rotor coils 215. The rotor coils 215 may be connected in series or parallel to the output of the RPU 216 to obtain a desired result.

Since high air gap sheer stresses may be generated, this may result in high mechanical forces on the rotor coils 215. Therefore, it may be important to wind the rotor coils 215 in a high strength coil former made from high strength suitable material and impregnated with epoxy resins. The input to the rotor coils may be DC.

A closed loop cryogenic refrigeration system 217 as shown in FIGS. 7 and 7A may be located outside the motor housing and connected to the cryostat by refrigerant transfer tube 217A and return tube 217B as shown in FIGS. 7 and 7A. The cryogenic refrigeration system 217 conducts heat from the rotor coils 215 and the stator coils 214 to the cryogenic refrigeration system 217, where the heat is dissipated. Cryogenic refrigeration system 217 maintains superconducting temperatures inside the cryostat 213 by circulating cryogenic refrigerant at superconducting temperatures. This keeps the stator coil 214 and rotor coils 215 in the superconducting state.

The rotor coils 215 may be connected to the rotor shaft 206 by a torque tube 218 and the outer surface of the torque tube also forms the support structures for the rotor coils 215. The function of torque tube 218 is to transfer the torque produced by the rotor coils 215 to the shaft 206. The torque tube 218 also acts as a heat shield between the cryostat and the shaft 206 exposed to outside warm temperatures. This reduces the thermal load on cryogenic refrigeration system. The separate sections of the shaft 206 where coil is not mounted contains torque tube extensions 218A which also insulates cryostat from the sections of shaft 206 exposed to warm temperatures.

An electromagnetic shield 219 is fabricated around the stator assembly 214 and is attached to vacuum jacket 112. The stator assembly 214 is secured to the housing by stator supports 220. The function of the RPU 216 is to transfer power to the rotating member and the RPU 216 may be located either inside the cryostat 213 or outside the housing 210 on the shaft 206.

Under the description of operating principles for rotor coils 215 perpendicular to the stator coil 214 is described in detail how different electromagnetic mechanisms generate the required torque for the rotor coils 215.

For the motor operation to take place the rotor coils 215 may be connected to the stator coil 214 and the stator coil 214 may be powered from PSS and rotor coils 215 may be powered with RPU 216.

Operating Principles of Superconducting Dc Motor with Multisided Rotor Coils Provided with Right Angle Extension

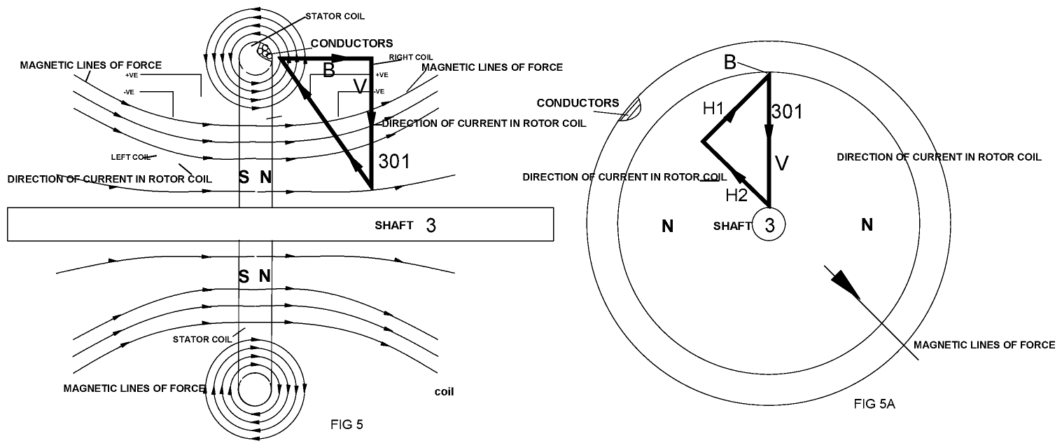

FIGS. 5 and 5A show the principle of motor action according to the present application. A stationary stator coil 2 may generate a magnetic field as shown in FIGS. 5 and 5A.

A rotating shaft 3 may be assembled as shown in FIGS. 5 and 5A. One coil 301 as shown in FIGS. 2B and 2C with sides B, V and a right angled extension consisting of sections H1 and H2 which are bent at right angles to the plane of sides B and V may be mounted on the shaft as shown in FIGS. 5 and 5A. Only one coil is shown to demonstrate the novelty and strength of the present application. It is possible to operate the motor with only one coil to demonstrate the principle of operation, but in actual practice a large number of coils may be assembled to meet desired specification. These coils link the magnetic field generated by the stator coil 2.

When the rotor coil 301 described in FIGS. 2B and 2C is supplied with DC current and with the direction of current as shown in FIGS. 5 and 5A the following actions take place.

Applying Fleming's left hand rule of the motor action to side B of the coil 301 which is parallel to the shaft 3 it will be observed that this action may cause the shaft to rotate when forces are generated on the coil sides B. In a similar manner side V of the coil 301 which is perpendicular to the shaft 3, it may be observed that this action causes the shaft to rotate when forces are generated on the coil side V. The coil sides B and V of coil 301 may tend to rotate the shaft depending on the direction of current in each coil side and the direction of the magnetic field which these sides link. The direction of torque produced by each coil side may be determined by the Fleming's left hand rule of motor action and this action may product final rotational effect on the rotation of the shaft 3.

Looking at the coil 301 from right to left towards the center of the shaft 3, the direction of current in the coil 301 may be shown in FIGS. 5 and 5A. Applying the Fleming's left hand rule of motor action, the coil side B of the coil 301 may generate the rotation of the coil in anticlockwise direction and simultaneously the coil side V of coil 301 may generate the rotation of the coil in anticlockwise direction. These two rotational forces may be in the same direction and the net rotational force exerted on the shaft may be the sum of torque produced by sides B and V in anticlockwise direction.

In a similar manner, applying the Fleming's left hand rule of motor action to the coil side extensions H1 and H2 of the multisided coil 302, it may be observed that the current flowing in right angle extensions H1 and H2 are in different directions to the current flowing in sides B and V. This may cause the torque produced by H1 and H2 in different direction to the torques produced by the sides B and V. The torques produced by the right angled extension H1 and H2 may rotate the coil and not the shaft 3. The right angled extension H1 may generate the rotation of the coil in clockwise direction which may be different than the direction of the torque produced by sides B and V. In a similar manner the right angled extension H2 of multisided coil 302 may generate the rotation of the coil in the anticlockwise direction. These two rotational forces generated by H1 and H2 may cancel each other and result in a net rotational force exerted on the shaft by H1 and H2 of zero the final rotational force produced by the coil will be the sum of rotational torques produced by coil sides B and V.

Selecting a flux density generated by stator coil 3 and the number of turns of stator and rotor coils and dimensions of the sides B, the motor may be able to produce desired values of torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art superconducting motors and generators. These design concepts and fully cryogenic refrigeration may produce more than double the power density and thus power output of a motor of similar size available in the prior art superconducting motors and generators.

Construction and Assembly of Superconducting Dc Motor with Rotor Coils Provided with Right Angle Extension

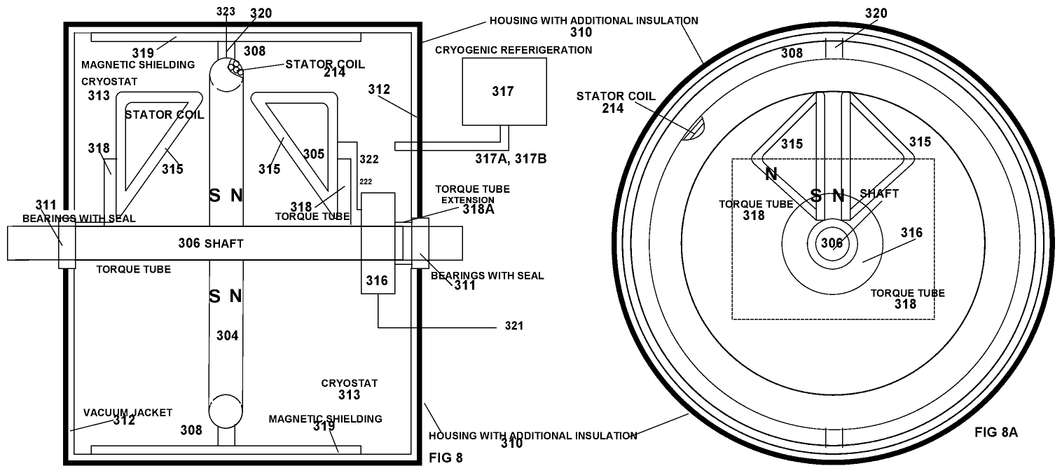

FIGS. 8 and 8A show the construction and integrated assembly of a superconducting motor with rotor coils with right angle extension.

The motor includes a stator assembly 304 and a rotor assembly 305. The rotor assembly 305 may be mounted on a rotating shaft 306 and the rotor assembly rotates as it magnetically links the stator assembly 304 by airgaps 307 and 307A. The magnetic field produced by one pole of the stator coil may be returned to the other pole by flux return path 308. The stator assembly 304 may be supported by stator supports 309. Both the stator assembly 304 and rotor assembly 305 may be mounted inside a motor housing 310. The rotating shaft 306 may be located on the motor housing 310 by two bearings 311 as shown in FIGS. 8 and 8A. A vacuum jacket 312 with extra insulation creates a structure within the motor housing 310. The stator assembly 304 and rotor assembly 305 may be mounted inside this structure. This structure may be defined as low temperature cryostat 313. The function of the cryostat 313 is to maintain superconducting temperatures for the stator coil 314 and rotor coils 315 to maintain superconducting properties to conduct superconducting currents and maintain flux. Both the stator coil 314 and rotor coils 315 are preferably wound with HTS 2G superconducting wires. This may allow motor operation below 77K.

A rotor power unit (RPU) 316 may be installed on the shaft 206. The RPU 316 has a rotating member and a stationary member. The stationary member may be mounted on the motor housing 310 and the rotating member may be mounted on the shaft 306. DC or AC power may be applied to the stationary member of the RPU 316 and electrical power transferred to the rotating member electromagnetically. The output of the rotating member may be connected to the rotor coils 315. The rotor coils 315 may be connected in series or parallel to the output of the RPU 316 to obtain a desired result.

Since high air gap sheer stresses may be generated this may result in high mechanical forces on the rotor coils 315. Therefore, it may be important to wind the rotor coils 315 in a high strength coil former made from high strength suitable material and impregnated with epoxy resins. The input to the rotor coils may be DC.

A closed loop Cryogenic refrigeration system 317 as shown in FIGS. 8 and 8A may be located outside the motor housing 310 and connected to the cryostat by refrigerant transfer tube 317A and return tube 317B as shown in FIGS. 8 and 8A. The cryogenic refrigeration system 317 conducts heat from the rotor coils 315 and the stator coil 314 to the cryogenic refrigeration system 117, where the heat is dissipated. Cryogenic refrigeration system 317 maintains superconducting temperatures inside the cryostat 313 by circulating cryogenic refrigerant at superconducting temperatures. This keeps the stator coil 314 and rotor coils 315 in the superconducting state.

The rotor coils 315 are connected to the rotor shaft 306 by means of torque tube 318 and the outer surface of the torque tube also forms the support structures for the rotor coils 315. The function of torque tube 318 is to transfer the torque produced by the rotor coils 315 to the shaft 306. The torque tube 318 also acts as a heat shield between the cryostat and the shaft 306 exposed to outside warm temperatures. This reduces the thermal load on cryogenic refrigeration system. The separate sections of the shaft 306 where coil is not mounted contains torque tube extensions 318A which also insulates cryostat from the sections of shaft 106 exposed to warm temperatures.

An electromagnetic shield 319 is fabricated around the stator assembly 314 and is attached to vacuum jacket 312. The stator assembly 304 is secured to the housing by stator supports 320.

Under the description of operating principles for rotor coils 315 right angled extension 314 is described in detail how different electromagnetic mechanisms generate the required torque for the rotor coils 315.

Operating Principles of Superconducting Dc Motor with the Plane of Rotor Coils Perpendicular or Horizontal to the Shaft

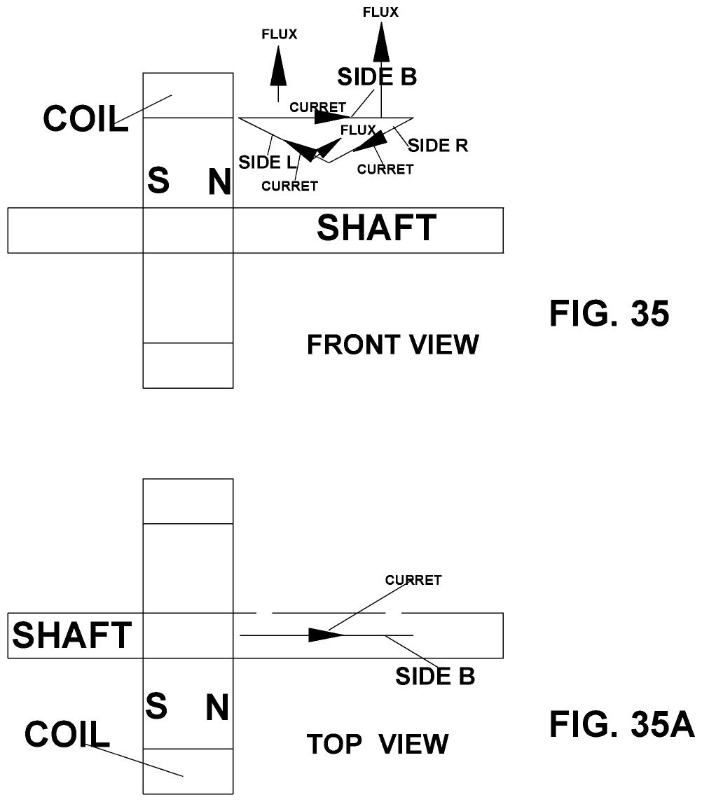

FIGS. 35 and 35A show the principle of motor action according to the present application where rotor coils can be used in two configurations. For the motor action the term stator and field and rotor and armature are used interchangeably. A stationary stator will include a stator coil and will generate magnetic field as shown in FIGS. 35 and 35A.

A rotating shaft is assembled as shown in FIGS. 35 and 35A. At least one coil as shown in FIGS. 35 and 35A with sides L, R and B are mounted on the shaft. In this embodiment the plane of the coil is perpendicular to the shaft. Only one coil is shown to describe the principle of operation but in actual practice a large number of coils may be assembled to meet desired specifications. This coil links the magnetic field generated by stator coil as shown in FIGS. 35 and 35A. The flux produced by the north pole of stator coil will be vertical near the circumference of the stator coil.

When the rotor coil is supplied with DC current and with the direction of current as shown in FIGS. 35 and 35A, the following actions takes place.

Applying Fleming's left hand rule of the motor action to Side B of the rotor coil which is parallel to the shaft it will be observed that this action will cause the shaft to rotate when forces are generated on the coil side B. The coil sides L and R of the rotor will tend to rotate the shaft depending on the direction of current in each coil side and the direction of the magnetic field which these sides link. The direction of torque produced by each coil side will be determined by the Fleming's left hand rule of motor action and this action will produce final rotational effect on the rotation of the shaft 703.

Looking at the rotor coil from right to left of this page towards the center of the shaft the direction of the current in the rotor coil will be as shown in FIGS. 35 and 35A. Applying the Fleming's left hand rule of motor action, the current in coil side B will be from left to right and direction of magnetic flux from the north pole of stator coil will be in vertical direction. This interaction will generate the rotation of the coil in anticlockwise direction and simultaneously applying the Applying the Fleming's left hand rule of motor action to the coil side R of the rotor coil, the coil side R will also generate the rotation of the coil in the antilock wise direction. In a similar manner Applying the Fleming's left hand rule of motor action to the coil side L of the rotor coil, the flux from north pole of stator coil will be interacting in the same direction. But the current will be in the opposite direction to that of coil side R This will generate the rotation of the coil in clockwise direction.

It will be observed that the rotational torque produced by coil sides B, R of the coil will in the same direction but the torque produced by coil side L will be in the opposite direction and the torque produced by sides L and R will cancel out each other and resultant torque produced by rotor coil will be the sum of torque produced by the coil sides B and R minus the torque produced by side L.

In a similar manner an embodiment can be designed with the plane of the coil parallel to the shaft the plane of the coil rotating circumferentially along the stator coil. Again, applying the Flemings left hand rule of motor action, to all the sides of the coil, the motor will produce rotation and torque in the desired direction.

Operating Principles of Superconducting DC Motor with Rotor Coils Perpendicular to the Two Opposing Stator Coils of Like Polarity

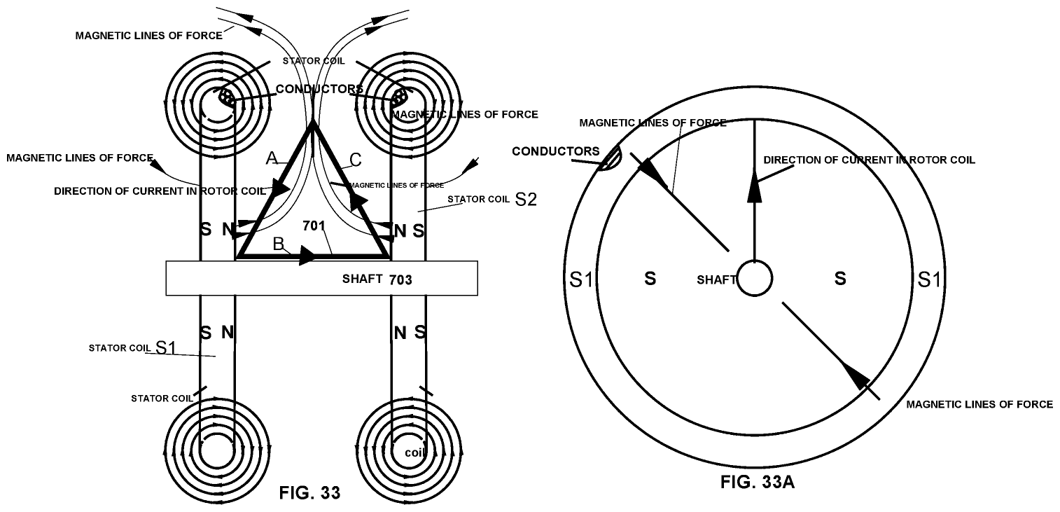

FIGS. 33 and 33A show the principle of motor action according to the present application where two stator coils are used. For the motor action the term stator and field and rotor and armature are used interchangeably. A stationary stator will include two stator coils of like polarity opposing each other and will generate magnetic field as shown in FIGS. 33 and 33A. The resultant field created by the 2 coils of like polarity is well understood in prior art and can be found in any literature on magnetic fields.

A rotating shaft 703 is assembled as shown in FIGS. 33 and 33A. At least one coil 701 as shown in FIGS. 33 and 33A with sides A, B, and C are mounted on the shaft. Only one coil is shown to describe the principle of operation but in actual practice a large number of coils may be assembled to meet desired specifications. This coil links the magnetic field generated by two stator coils S1 and S2 of like polarity as shown in FIGS. 33 and 33A. The flux produced by the north pole of coil S1 will interact with the flux produced by the north pole of coil S2. There will be a zone of zero magnetic fields between the two coils and the direction of the lines of magnetic field from coils S1 and S2 will be vertical near the circumference of the two coils.

When the rotor coil 701 is supplied with DC current and with the direction of current as shown in FIGS. 33 and 33A, the following actions takes place.

Applying Fleming's left hand rule of the motor action to Side A of the rotor coil 701 which is perpendicular to the shaft 703 it will be observed that this action will cause the shaft to rotate when forces are generated on the coil side A. The coil sides B and C of coils 701 and will tend to rotate the shaft depending on the direction of current in each coil side and the direction of the magnetic field which these sides link. The direction of torque produced by each coil side will be determined by the Fleming's left hand rule of motor action and this action will produce final rotational effect on the rotation of the shaft 703.

Looking at the coils 701 from right to left of this page towards the center of the shaft 703 the direction of the current in the coil 701 will be as shown in FIGS. 33 and 33A. Applying the Fleming's left hand rule of motor action, the current in coil side A will be from top to bottom and direction of magnetic flux from the north pole of stator coil S1 will be from left to right of the coil 701. This interaction will generate the rotation of the coil in anticlockwise direction and simultaneously applying the Applying the Fleming's left hand rule of motor action to the coil side C of the coil 701, coil side C will also generate the rotation of the coil in the antilock wise direction. These two rotational forces will be in the same direction and the net rotational force exerted on the shaft will be the addition of the force generated by the sides A and C.

In a similar manner Applying the Fleming's left hand rule of motor action to the coil side B of the coil 701, the flux from both north poles of stator coils S1 and S2 will be interacting in the same direction. This will also generate the rotation of the coil in anticlockwise direction.

It will be observed that the rotational torque produced by coil sides A, B and C of the coil 701 will in the same direction and the resultant torque produced by coil 701 will be the sum of torque produced by the coil sides A, B and C of coil 701.

It will be observed that in the embodiment of the superconducting motor with two stator coils, the torque produced by the motor will be contributed by all the coil sides of the rotor coils. This will offer higher power density for the rotor. This will result in lower rotor inertia and applications where lower rotor inertia and higher power density is desired this motor will offer an attractive solution.

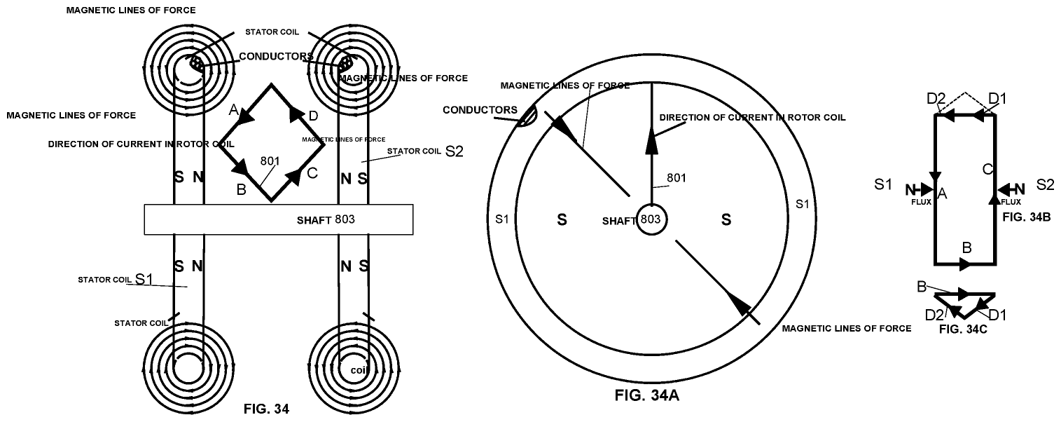

FIGS. 34 and 34A shows the principle of motor action according to the present invention where two stator coils are used. For the motor action the term stator and field and rotor and armature are used interchangeably. A stationary stator will include two stator coils of like polarity opposing each other and will generate magnetic field as shown in FIGS. 34 and 34A. The resultant field created by the 2 coils of like polarity is well understood in prior art and can be found in any literature on magnetic fields.

A rotating shaft 803 is assembled as shown in FIGS. 34 and 34A. At least one coil 801 as shown in FIGS. 34 and 34A with sides A, B, C and D are mounted on the shaft. Only one coil is shown to describe the principle of operation but in actual practice a large number of coils may be assembled to meet desired specifications. This coil links the magnetic field generated by two stator coils S1 and S2 of like polarity as shown in FIGS. 34 and 34A. The flux produced by the north pole of coil S1 will interact with the flux produced by the north pole of coil S2. There will be a zone of zero magnetic fields between the two coils and the direction of the lines of magnetic field from Coils S1 and S2 will be vertical near the circumference of the two coils.

In this embodiment the coil has 4 sides as shown in FIGS. 34 and 34A. The sides A and B link the flux produced by stator coil S1 and the coil sides C and D link the flux produced by stator coil S2 as shown.

When the rotor coil 801 is supplied with DC current and with the direction of current as shown in FIGS. 34 and 34A, the following actions takes place.

Applying Fleming's left hand rule of the motor action to Sides A and B of the rotor coil 801 which is perpendicular to the shaft 803 it will be observed that this action will cause the shaft to rotate when forces are generated on the coil sides A and B. The coil sides C and D of coils 801 and will tend to rotate the shaft depending on the direction of current in each coil side and the direction of the magnetic field which these sides link. The direction of torque produced by each coil side will be determined by the Fleming's left hand rule of motor action and this action will produce final rotational effect on the rotation of the shaft 803.

Looking at the coils 801 from right to left of this page towards the center of the shaft 803 the direction of the current in the coil 801 will be as shown in FIGS. 34 and 34A. Applying the Fleming's left hand rule of motor action, the current in coil sides A and B will be from top to bottom and direction of magnetic flux from the north pole of stator coil S1 will be from left to right of the coil 801. This interaction will generate the rotation of the coil in anticlockwise direction and simultaneously applying the Applying the Fleming's left hand rule of motor action to the coil sides C and D of the coil 801, coil sides C and D will also generate the rotation of the coil in the antilock wise direction. These two rotational forces will be in the same direction and the net rotational force exerted on the shaft will be the addition of the force generated by the sides A, B, C and D.

It will be observed that the rotational torque produced by coil sides A, B, C and D of the coil 801 will in the same direction and the resultant torque produced by coil 801 will be the sum of torque produced by the coil sides A, B, C and D of coil 801.

It will be observed that in the embodiment of the superconducting motor with two stator coils, the torque produced by the motor will be contributed by all the coil sides of the rotor coils. This will offer higher power density for the rotor. This will result in lower rotor inertia and applications where lower rotor inertia and higher power density is desired this motor will offer an attractive solution.

FIGS. 34B and 34C shows the principle of motor action by a coil with 5 sides with two parallel sides interacting with the two north poles of like polarity as shown in FIGS. 34B and 34C and magnetic interaction described earlier in embodiments with two stator coils.

The dotted line as shown in FIG. 34B demonstrates how the coil is originally wound with five sides. The sides D1 and D2 are then bent at right angles to sides A and C.

In the motor action the sides A and C as shown in FIGS. 34B and 34C will interact with two north poles of S1 and S2 and will produce the torque in the same direction. Similarly the side B will also produce the torque in the same direction as sides A and C. the sides D1 and D2 will however produce torque in opposite direction and will cancel each other. This will allow the coil sides A, B and C to produce the torque in the same direction. And the resultant torque produced by the coil will be the sum of torque produced by the coil sides A, B and C of the coil.

Construction and Assembly of Superconducting DC Motor with Rotor Coils Perpendicular to the Stator Coils with Two Opposing Stator Coils of Like Polarity

FIGS. 6 and 6A shows the construction and integrated assembly of a superconducting motor with rotor coils perpendicular to the stator coil.

In the embodiment of the motor with two stator coils the construction and assembly of the motor will be identical the motor assembly described in FIGS. 6 and 6A. The difference in the final construction and assembly will be the stator assembly with two stator coils replacing one stator coil. The rotor coils will be located between the two stator coils.

The cryogenic cooling system and construction related to the combined stator and rotor cryostat will be identical. The power transfer scheme to the rotor also will be identical.

Generator Action with Two Opposing Stator Coils of Like Polarity

FIGS. 33, 33A, 34, 34A, 34B and 34C describes the embodiments of a motor with two stator coils with poles of like polarity interacting with rotor coils.

The principles of motor action can also be applied to generator action by reversing the function of the stator and rotor. Coils described in FIGS. 33 and 33A can be operated as stationary armature of generator by assembling them on stationary armature and rotating the two coils of opposing polarity linking this coil. Also Coils described in FIGS. 34 and 34A can be operated as stationary armature of generator by assembling them on stationary armature and rotating the two coils of opposing polarity linking this coil.

In the generator action the field coils may be rotating and the field excitation power may be supplied with proper exciter action as described earlier. The output power may be produced by the stationary armature coils.

### Connection Schemes for Stator and Rotor for Operation of Superconducting Dc Motor

The present application offers performance characteristics and cost and size advantage not available in prior art electrical machines. Constant torque and smooth speed control are two of the main advantages. The electrical connection between the armature and field will be presented to achieve maximum benefits of the new concept.

There are 5 main connection schemes for the operation of DC motor in different operational modes. The selected DC motor stator (field) and rotor (armature) connections determine which operational mode the DC motor will operate in. DC power has to be applied to both stator and rotor coils by one of the four connections schemes.

1. Separately excited DC motor

2. Shunt DC motor

3. Series DC motor

4. Compound DC motor

5. AC transformer controlled DC motor.

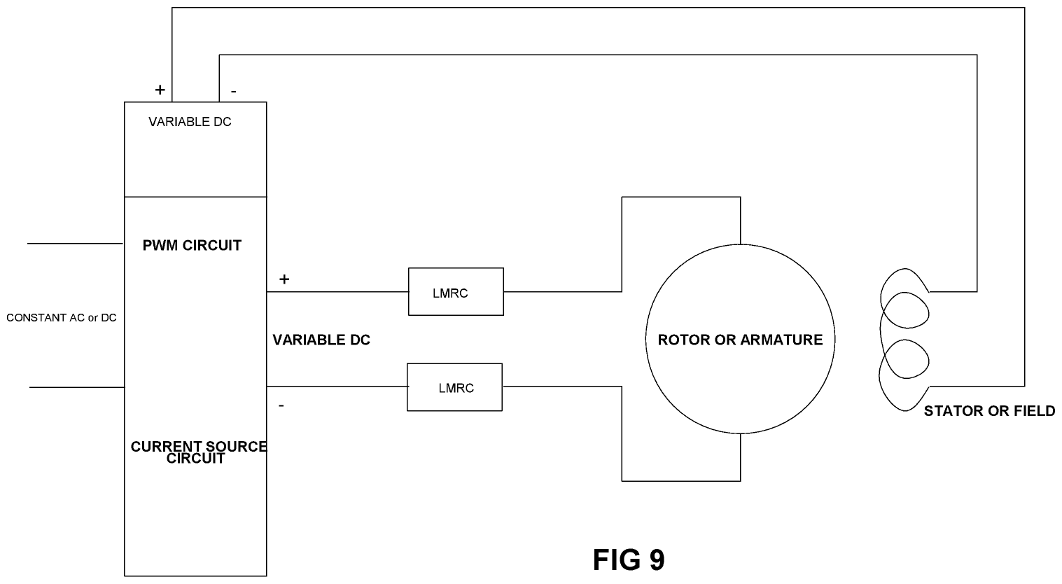

FIGS. 9 through 17 further describes 5 primary connection configurations by which rotor coils are connected to stator coil. The rotor power unit (RPU) supplies power to the rotor coils from a stationary source s without any physical connection or contacts that are subject to wear and tear between the stationary source and the rotor coils. It includes a stationary member and a rotating member. This arrangement makes it possible to implement a brushless commutatorless design configuration. Since there is no physical connection between the stationary and the rotating member of the RPU therefore no wear and tear occurs during the power transfer and ongoing maintenance is not required.

The rotor power unit (RPU) is used in 6 different design configurations.
1. Liquid metal rotating contacts (LMRC): In this connection method the stationary and rotating members of the rotor power unit (RPU) consists of liquid metal contacts and the stationary and rotating members are connected by liquid metal. In this method the DC power is applied directly to the rotor since the connection is made directly with the rotor coils through the liquid metal.
2. Conventional rotatable transformer: In this connection method the power is transferred through the airgap where the stationary member is the primary and the rotating member is the secondary of the rotatable transformer. Power is supplied to the primary and the rotor coils are connected to the secondary using proper rectifier and filter scheme for the DC power.
3. Superconducting rotatable transformer: In this method of connection the power is transferred through the airgap where the primary of the superconducting rotatable transformer is the stationary member and is provided with superconducting winding while the secondary of the rotatable transformer is the rotating member and is connected to the rotor coils and provided with superconducting winding. Power is supplied to the primary and the rotor coils are connected to the secondary using proper rectifier and filter scheme for the DC power.
4. Conventional switch mode rotatable transformer: The technology relating PWM (pulse width modulation) power supply is very advanced and widely used to provide DC power to a variety of electrical and electronic equipment. The technology to design and build PWM power supply is readily available in the industry. With the availability of low cost PWM systems it is possible to develop cost effective power supply architectures for the brushless transfer of power to the rotor of the motor according to the requirement of each motor. In a rotatable switch mode power transformer the power is transferred through the airgap from the stationary primary winding to the rotating secondary winding where rotor coils are located. The stationary member which is the primary is provided with switched DC power and the rotating member which is the secondary of the switch mode rotatable transformer is provided with rectifier and filter circuit to provide necessary DC power to the rotor coils. It is also possible to step up or down the voltage and current when needed. Power is supplied to the primary and the rotor coils are connected to the secondary to provide necessary torque to the shaft.
5. Superconducting switch mode rotatable transformer: The technology relating PWM (pulse width modulation) power supply is very advanced and widely used to provide DC power to a variety of electrical and electronic equipment. Technology to design and build PWM power supply is readily available in the industry. With the availability of low cost PWM systems it is possible to develop cost effective power supply scheme for the brushless transfer of power to the rotor of the motor according to the requirement of each motor. In a superconducting rotatable switch mode power transformer, the power is transferred through the airgap from the superconducting stationary primary winding to the rotating superconducting secondary winding where rotor coils are located. The stationary member which is the superconducting primary is provided with switched DC power and the rotating member which is the superconducting secondary of the switch mode rotatable transformer is provided with rectifier and filter circuit to provide necessary DC power to the rotor coils. Power is supplied to the primary and the rotor coils are connected to the secondary to provide necessary torque to the shaft.
6. Long life slipring assembly: the technology of slipring assemblies for electrical devices and machines has developed to a state where very reliable and inexpensive sliprings with long operational life is readily available. With the availability of these advanced sliprings it is possible to use them in applications where low cost brushless operation is required. The sliprings can be readily adapted to PWM power operation. Sliprings can be used in place of LMRC for low cost applications and where sliprings offers compact and simple solution.

DC motors have been employed in large number of different applications in most industries for more than a century. Because of the vast experience gained during the time in design methodologies and manufacturing methods, the DC motors can be effectively designed and manufactured for any desired application. This knowledge can be applied to the present invention. The novel and innovative difference is that brushes and commutators are eliminated.

POWER SUPPLY SUBSYSTEM: The function of the power supply subsystem (PSS) is to supply DC power to the armature and field winding of the DC motor. In applications where conventional or superconducting transformers are used, the PSS provides AC power as needed.

PWM method of voltage control is very efficient and cost-effective way to generate DC power compared to other methods currently used for the control of superconducting motors. PWM method is very effective for the control of DC motor according to the present invention. It can also generate variable AC if needed.

Variable DC is generated by a dedicated PWM circuit for the application of DC voltage to the armature and this voltage is supplied to the armature by one of the 6 methods described earlier.

Variable DC is also generated by a second dedicated field control PWM circuit for the application of DC voltage to the field circuit and this voltage is supplied to the field circuit by one of the 6 methods described earlier.

A current source circuit is also provided on the PSS. Current source limits the maximum current that can be supplied to the motor. When coils reach superconducting state the resistance of the coil becomes zero. And when voltage is applied to the coil in the superconducting state a large current will flow and if this current exceeds the critical current for the superconducting wires of the coils a catastrophic failure termed quenching comes into existence. This is effectively controlled by the current source circuit.

When operated as DC motor the operational characteristics of the motor are determined by the connection between the stator coils and the rotor coils. FIGS. 9 to 17 shows different connection schemes for DC motor to obtain different operational characteristics.

As stated earlier there are six main connection schemes for operation of DC motor in different modes. We will now describe each connection scheme in detail. Another important requirement to be considered is the availability of current source power for the superconducting motors. Current source limits the maximum current that can be supplied to the motor. When coils reach superconducting state the resistance of the coil becomes zero. And when voltage is applied to the coil in the superconducting state a large current will flow and if this current exceeds the critical current for the superconducting wires of the coils a catastrophic failure termed quenching comes into existence.

SEPARATELY EXCITED DC MOTOR: The stator and rotor coils of the motor are supplied with DC power separately. DC power can be connected directly to the stator coil and DC power can be supplied to the rotor coils by means of one of the six methods described earlier. Speed control of the motor is achieved by controlling the voltage to stator or rotor.

FIG. 9 shows the connection scheme for separately excited motor using Liquid metal rotating contacts (LMRC). The same scheme can be applied to sliprings when used. Separate source of DC power is used for rotor (armature) and stator (field) connection. As shown the power supply subsystem provides DC power with variable voltage to the armature by LMRC and the field is separately supplied with independent variable DC voltage directly from the power supply subsystem. When LMRC is used the rectification and filtering for the armature PWM circuit is done on the PSS and only distortion free DC is applied to the armature. The rectification and filtering for the field circuit is also performed on the PSS. The DC motor speed is controlled by independently controlling the voltage applied to the armature and to the field winding of the motor.

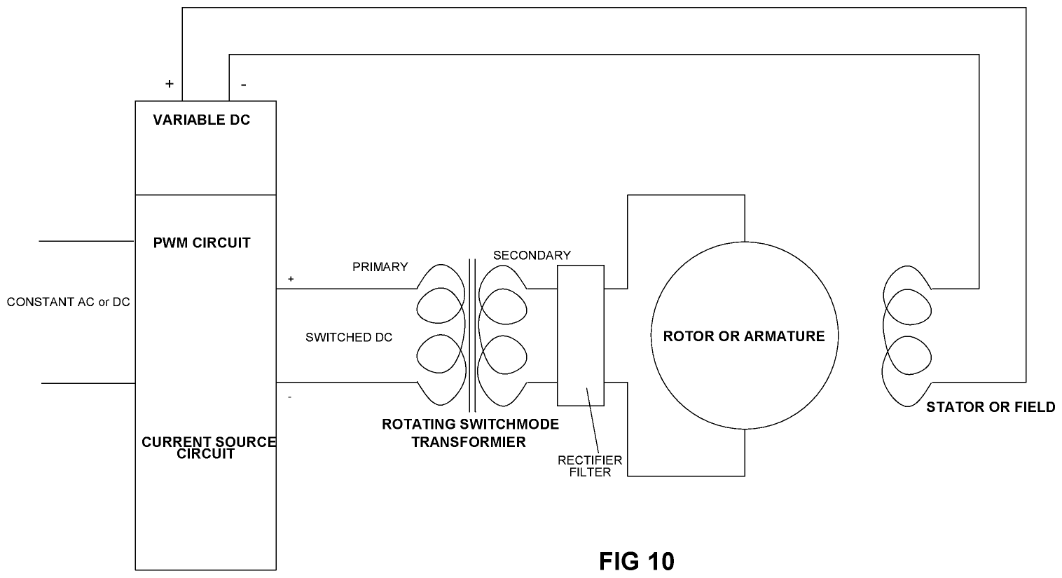

FIG. 10 shows the connection scheme for separately excited motor using rotatable switch mode transformer (RSMT). The same scheme can be applied to sliprings when used. Separate source of DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. As shown the power supply subsystem provides DC power with variable voltage to the armature by rotatable switch mode transformer (RSMT). And the field is separately supplied with independent variable DC voltage directly supplied by the power supply subsystem. The DC motor speed is controlled by independently controlling the voltage applied to the armature and to the field winding of the motor.

PERFORMANCE CHARACTERISTICS: When constant current is maintained in the armature by PSS and variable voltage is supplied to the field circuit a smooth speed control of the motor is achieved.

It is also possible to control and achieve speed control by simultaneously varying both armature and field voltage. This method will allow the motor to operate in different torque and speed characteristics.

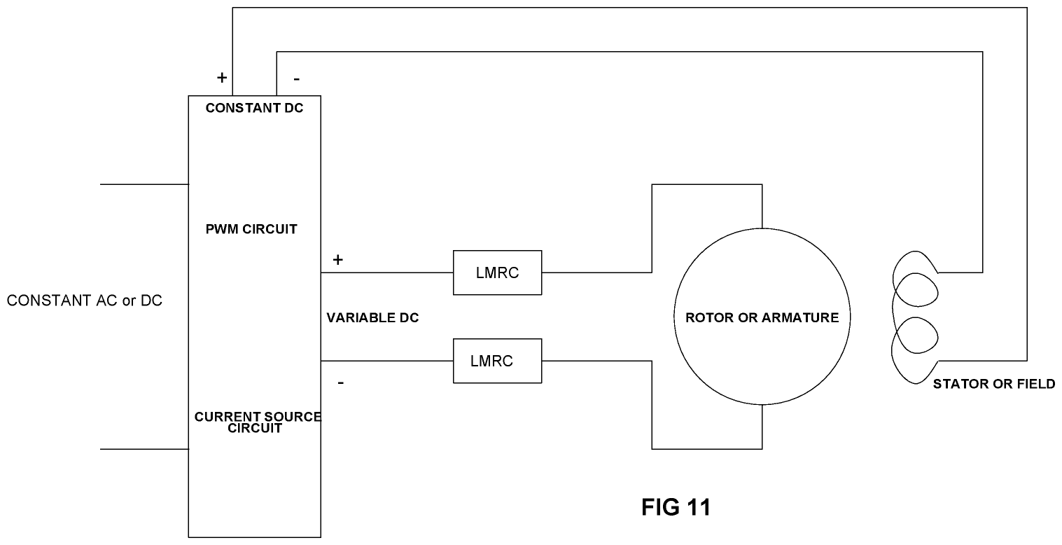

DC SHUNT MTOR: DC shunt motor is one of the most widely used DC motor FIG. 11 shows the connection scheme for a DC shunt motor utilizing liquid metal rotating contacts (LMRC). The rotor and stator are connected in parallel. The same scheme can be applied to sliprings when used. Separate source of DC power is used for rotor (armature) and stator (field) connections. As shown the power supply subsystem provides DC power with variable voltage to the armature by LMRC and the field is separately supplied with independent variable DC voltage directly from the power supply subsystem shows the connection scheme for DC shunt motor using. The rectification and filtering for the field circuit is also performed on the PSS. The DC motor speed is controlled by independently controlling the voltage applied to the armature and to the field winding of the motor.

Most widely used speed control method for DC shunt motor is maintaining constant voltage to the field circuit and supplying variable voltage to the armature.

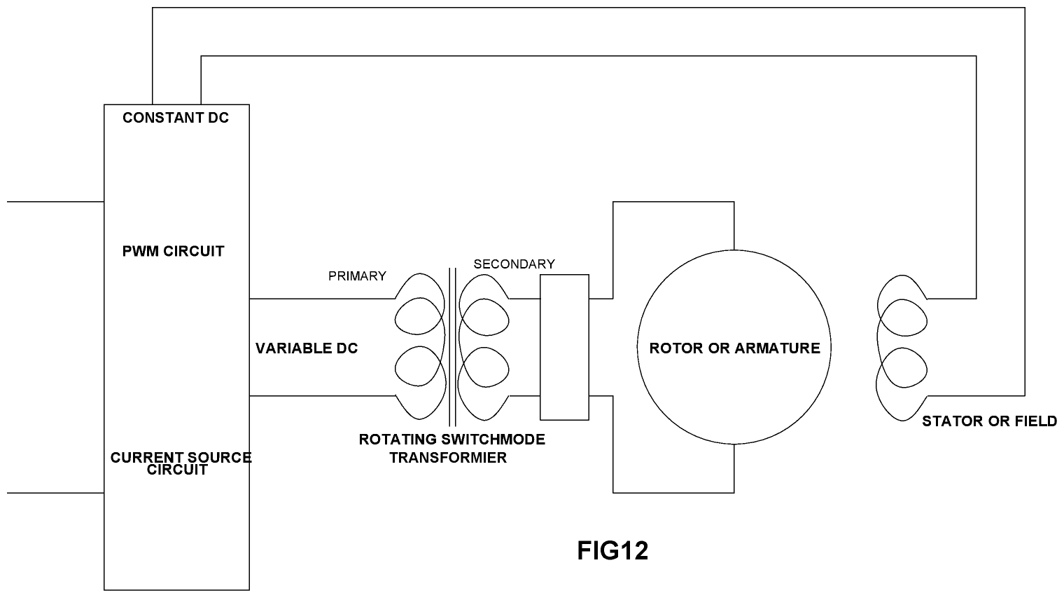

FIG. 12 shows the connection scheme for DC shunt motor using rotatable switch mode transformer (RSMT). Separate source of DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. As shown the power supply subsystem provides DC power with variable voltage to the armature by rotatable switch mode transformer (RSMT). And the field is separately supplied with independent variable DC voltage directly supplied by the power supply subsystem. The DC motor speed is controlled by independently controlling the voltage applied to the armature and to the field winding of the motor.

Most widely used speed control method for DC shunt motor is maintaining constant voltage to the field circuit and supplying variable voltage to the armature.

PERFORMANCE CHARACTERISTICS: When constant voltage is maintained to the field circuit and variable voltage is supplied to the armature by PSS, a smooth speed control of the motor is achieved. The motor also maintains constant torque over wide speed range. Both speed and acceleration can be accurately controlled by this method. DC shunt motor has excellent speed regulation at different load conditions.

It is also possible to control and achieve speed control by simultaneously varying both armature and field voltage. This method will allow the motor to operate in different torque and speed characteristics.

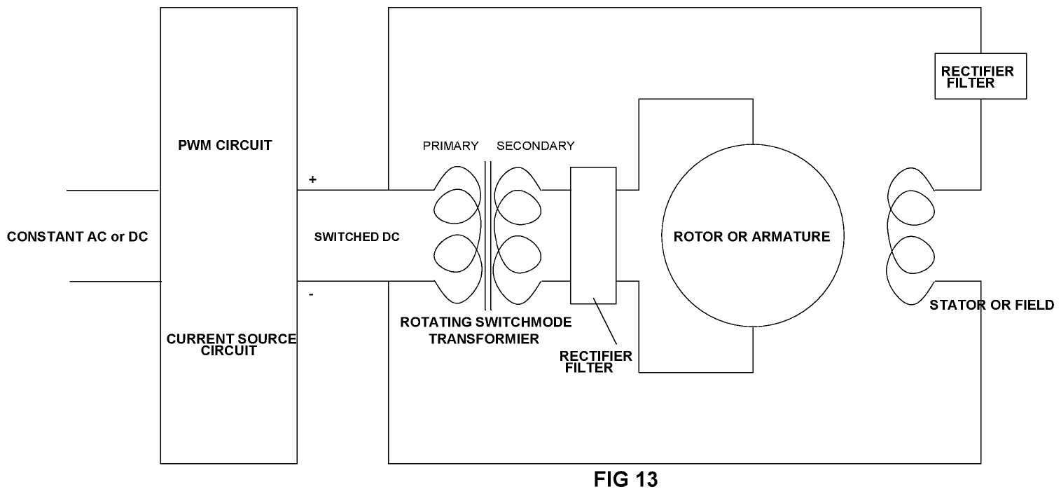

DC MOTOR WITH VARIABLE VOLTAGE OPERATION: FIG. 13 shows the connection scheme for DC shunt motor using rotatable switch mode transformer (RSMT) where both the armature and the shunt field are provided with variable DC power. Same source of variable DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. The field is also provided with the rectification and filtering circuit. As shown the power supply subsystem provides DC power with variable voltage to the armature and field by rotatable switch mode transformer (RSMT).

FIG. 13A shows the connection scheme for DC shunt motor using LMRC. The rectification and filtering for the field circuit is performed on the PSS. Desired variable voltage is applied to both the armature and the field winding through LMRC.

PERFORMANCE CHARACTERISTICS: When constant voltage is maintained to the field circuit and variable voltage is supplied to the armature by PSS, a smooth speed control of the motor is achieved. Both speed and acceleration can be accurately controlled by this method.

It is also possible to control and achieve speed control by simultaneously varying both armature and field voltage.

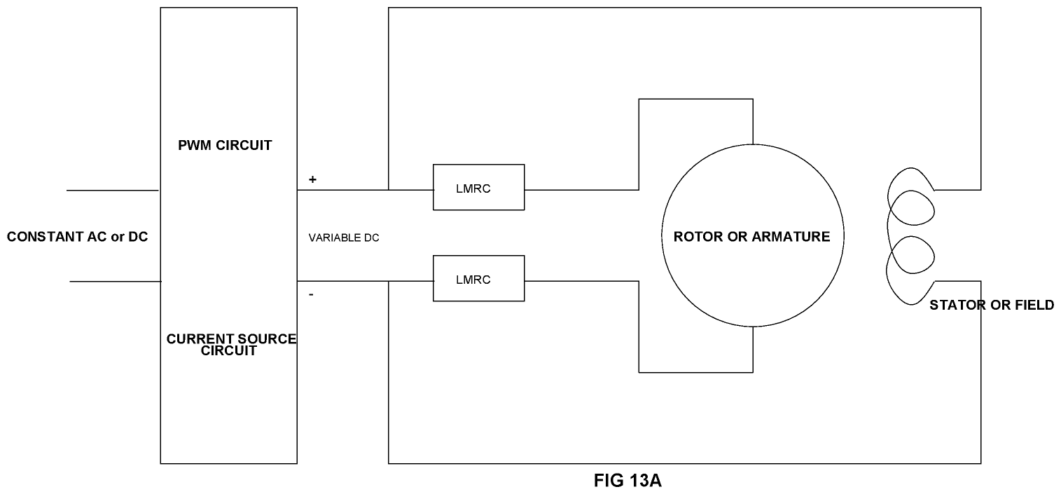

AC TRANSFORMER CONTROLLED DC MOTOR: FIG. 14 shows the connection scheme for DC shunt motor using AC transformer. The AC transformer can be of conventional design or superconducting design. The same scheme can be applied to sliprings when used. Separate source of DC power is used for rotor (armature) and stator (field) connection. When AC transformer is used for supplying the power to the armature, variable AC is provided to the primary of the AC transformer and the secondary located on the rotating shaft is provided with the rectification and filtering circuit to supply distortion free DC to the armature. As shown the power supply subsystem provides variable AC voltage to the armature by AC transformer. And the field is separately supplied with independent variable DC voltage directly supplied by the power supply subsystem. The AC transformer scheme is not as efficient as the PWM speed control. The DC motor speed is controlled by independently controlling the voltage applied to the armature and to the field winding of the motor. Fig shows the AC transformer employed to control a DC shunt motor. It is also possible to employ other methods to control the speed of DC motor using AC transformer.

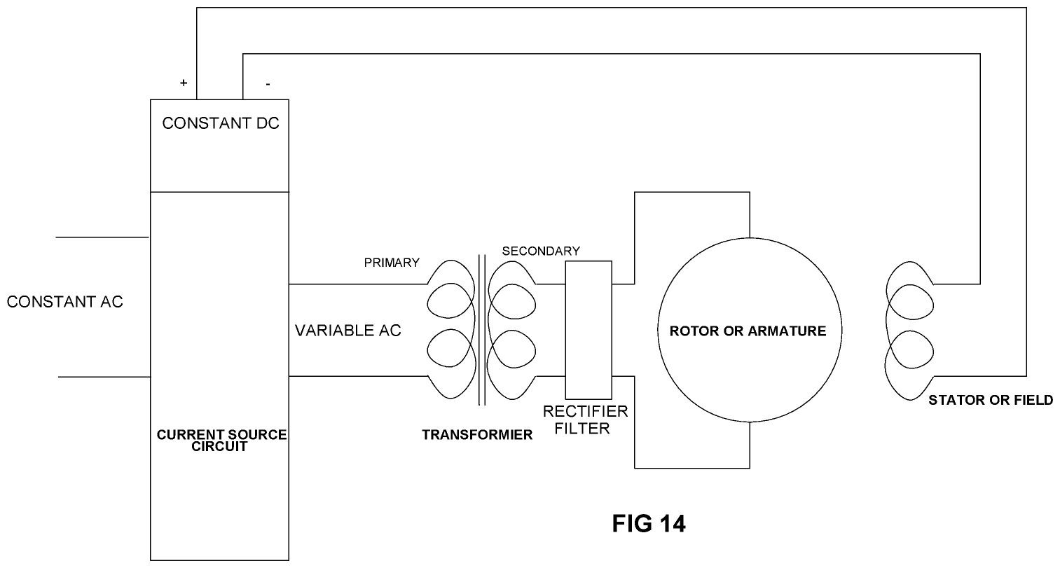

DC SERIES MOTOR: DC series motor has unique starting and running torque characteristics which is not found in any other motor type. FIG. 15 shows the connection scheme for a DC series motor utilizing liquid metal rotating contacts (LMRC). The rotor and stator are connected in series. The same scheme can be applied to sliprings when used. Same source of DC power is used for rotor (armature) and stator (field) connections. As shown the power supply subsystem provides DC power with variable voltage to the armature and the field, since they are connected in series by LMRC. When LMRC is used the rectification and filtering for the armature and field PWM circuit is done on the PSS and only distortion free DC is applied to the armature and field. The DC series motor speed is controlled by controlling the voltage applied to the armature and to the field winding of the motor.

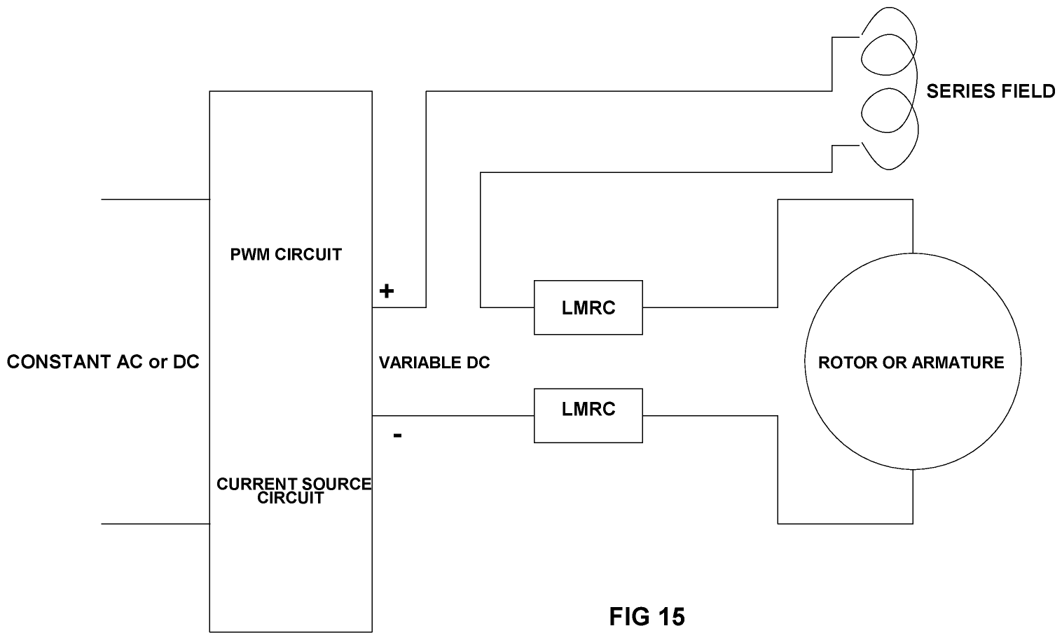

FIG. 16 shows the connection scheme for a DC series motor utilizing RSMT. The rotor and stator are connected in series by the primary of the RSMT. Same source of DC power is used for rotor (armature) and stator (field) connections since they are connected in series. As shown the power supply subsystem provides DC power with variable voltage to the armature and the field which are connected in series with the primary of the RSMT. The field winding is provide with rectification and filtering for the field circuit this will provide distortion free DC to the armature and the field. The RSMT for series motor is specially designed with the ability of the primary of the RSMT to handle both armature and field current in series. This design requires proper current rating for the primary of the RSMT and required turns ratio to induce required voltage in the secondary which is connected to the armature and provided with rectification and filtering for the field circuit which will provide distortion free DC to the armature. The DC series motor speed is controlled by controlling the voltage applied to the armature and to the field winding of the motor.

PERFORMANCE CHARACTERISTICS: the main characteristic of the series motor is high starting torque which is dependent on square of the armature current When constant voltage is maintained to the field circuit and variable voltage is supplied to the armature by PSS, a smooth speed control of the motor is achieved. Both speed and acceleration can be accurately controlled by this method.

It is also possible to control and achieve speed control by simultaneously varying both armature and field voltage.

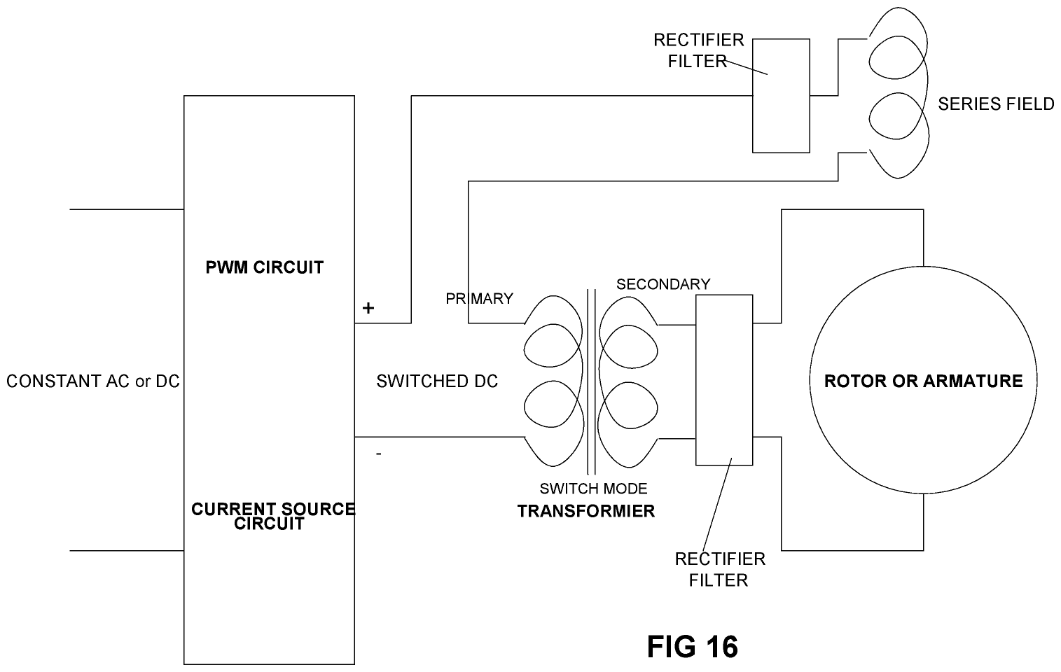

DC COMPOUND MTOR: FIG. 17 shows the connection scheme for a DC compound motor utilizing LMRC. The compound motor has a series winding and a shunt winding in addition to the armature winding located on the armature of the motor. The rotor and stator are connected in series by the LMRC. In addition the shunt winding is connected in parallel to the armature by connecting to the input DC from the PSS as shown in FIG. 17. Same source of DC power is used for rotor (armature) and stator (field) connections since they are connected in series. Same source of DC power is also connected to the shunt winding. As shown the power supply subsystem provides DC power with variable voltage to the armature and the series field which are connected in series with the LMRC contacts and the armature winding. When LMRC is used the rectification and filtering for the armature and field PWM circuit is done on the PSS and only distortion free DC is applied to the armature and series and shunt field winding. The DC compound motor speed is controlled by controlling the voltage applied to the armature and to the series field and shunt field winding of the motor.

PERFORMANCE CHARACTERISTICS: the compound motor offers advantages of both shunt and series motor by providing high starting torque and good speed regulation. This is achieved by simultaneously varying both armature and field voltage. When variable voltage is applied to the compound motor by PSS, a smooth speed control of the motor is achieved. Both speed and acceleration can be accurately controlled by this method.

### Detailed Description of Superconducting Dc Generator

Operating Principles of Superconducting Dc Generator with Stator Coils with Right Angled Extension

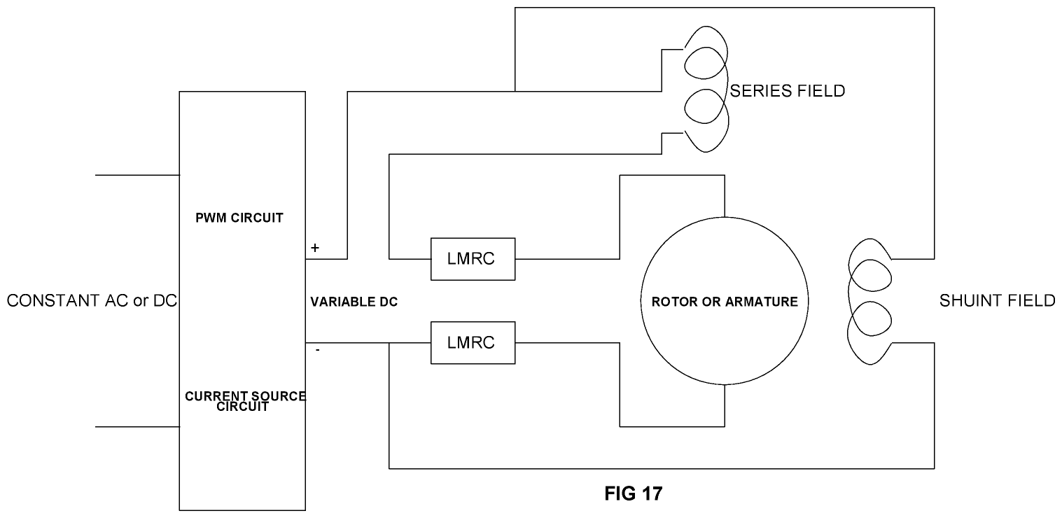

FIG. 18 shows the connection schematic for a superconducting DC generator according to the present application.

The DC generator 400 includes the following major parts working to obtain the required operation. For the generator action the term stator and armature and rotor and field are used interchangeably.

The armature coils 401 of the generator will be stationary and mounted on the machine housing. The armature will magnetically link a rotating field coil 403 mounted on shaft 404.

On the same shaft is also mounted a superconducting brushless exciter armature 405. The rotating armature magnetically links a stationary brushless exciter field coil 406. The rotating armature 405 of the brushless exciter provides excitation power to the generator field coil 403.

A voltage regulator 408 is used to control the output voltage of the generator under changing load conditions. Function and technology of the voltage regulator 408 is known in prior art and will not be repeated in detail.

The brushless exciter field coil 406 is connected to a field coil power supply 407. The power supply is controlled by a voltage regulator 408. The voltage regulator has 3 primary inputs and one output.

The output voltage of the generator is monitored and sampled by 409 and is an input the voltage regulator 408.

The output voltage of the generator is compared with target reference voltage 410 and is an input the voltage regulator 408.

An error signal 411 is generated from the voltage regulator 408 based on the deviation of output voltage from the target reference and provides information to field coil power supply 407 to change the power input to the field coil to adjust the voltage output to the target reference.

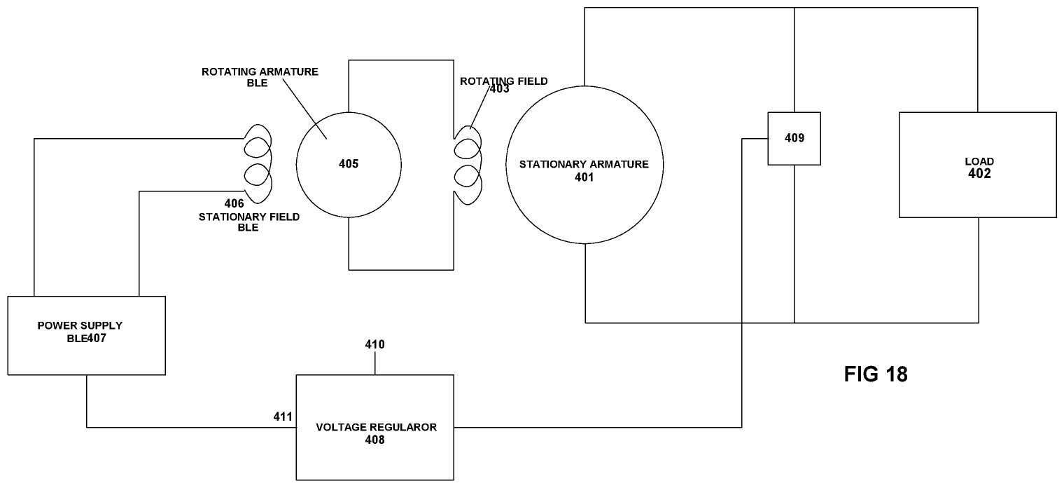

FIGS. 19 and 19A shows the principle of generator action according to the present application. A rotating field coil 403 will generate magnetic field as shown in FIGS. 19 and 19A.

The rotating field coil 403 is mounted on shaft 402. And the rotating shaft 402 is assembled as shown in FIGS. 19 and 19A. One instance of armature coils 401 is positioned as stationary coil 412 as shown in FIGS. 19 and 19A with sides B, V and right-angle extensions H1 and H2. The coil 412 is mounted on the generator housing as shown in FIGS. 19 and 19A. The generator coil configuration is selected whereby the coil side B of coil 412 is mounted parallel to the shaft. This will provide flux linkage with the rotating stator coil 403. Only one coil is shown to describe the principle of operation but in actual practice a large number of coils are assembled to meet desired specifications. These coils link the magnetic field generated by the rotating field coil 403.

When the rotating field coil is supplied with DC excitation current and the coil is rotated in the clockwise direction looking from right to left of this page towards the center of the shaft 402, as shown in FIGS. 19 and 19A the following actions take place.

Applying Fleming's right hand rule of the generator action to Sides B of the coil 412 which is parallel to the shaft 402 and it will be observed that this action will cause the voltage to be generated in the coil sides V and H1, H2 of coil 412, the direction of which is indicated in FIGS. 19 and 19A. The voltage induced in each coil side will depend on the direction of rotation of coil and on the direction of magnetic field each coil side links. The direction of induced voltage produced by each coil side will be determined by the Fleming's right hand rule of generator action and this action will produce final effect on the direction of voltage induced in coil 412.

Looking at the coil 412 from right to left of this page towards the center of the shaft 404 the direction of current in the coil 412 will be as shown in FIGS. 19 and 19A. Applying the Fleming's right hand rule of generator action, the coil side B of coil 412 will generate the voltage with the polarity indicated in FIGS. 19 and 19A and the same time the coil side V of coil 412 will also generate the voltage indicated in FIGS. 19 and 19A. The polarity of the voltage generated in side B of coil 412 will be from left to right of this page and the polarity of the voltage generated in side V of coil 412 will be from top to bottom of this page. The voltage in side B of 112 will be in same direction to the voltage induced by side V of the coils 412. In a similar manner applying the Fleming's right hand rule of generator action to the coil sides H1 and H2 of coil 412, will generate the voltage indicated in FIGS. 19 and 19A. The voltage in side B of coil 412 will add to the voltage induced by side V of the coil 412. The voltage generated by sides H1 and H2 will be in the same direction and will add to the total output voltage of right-angled side of the coil. The final output voltage will be the sum of voltage generated by sides B and V minus the voltage generated by the sides H1 and H2.

By selecting the flux density generated by field coil 3 and the number of turns of field and armature coils and dimensions of the sides B, V and H1 and H2, the generator will be able to produce desired values of voltage and power output of the generator. It is possible to generate voltages in the range of 1000 KV or higher which will not require step-up transformer and DC voltages can be transmitted directly. The fully cryogenic design of the generator will eliminate rotor coupling for refrigerant and associated cost, reliability problems and maintenance involved.

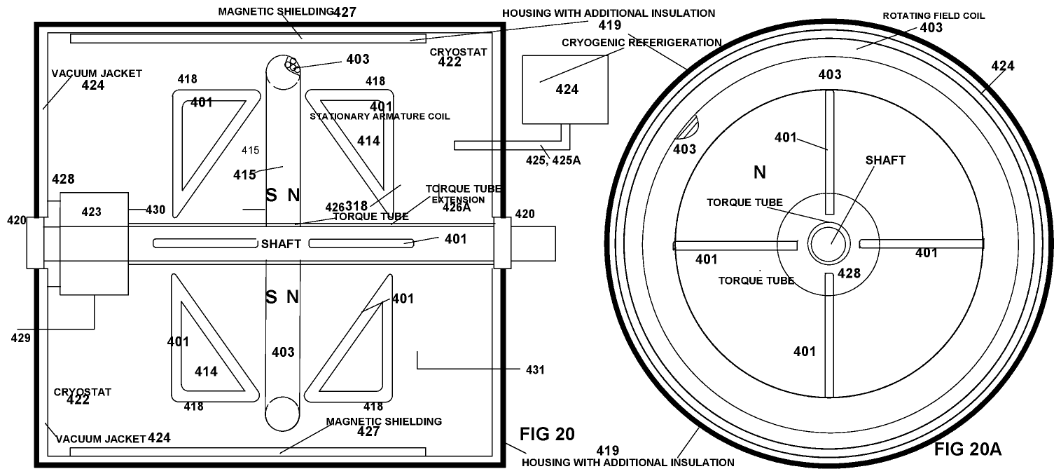

Different designs of rotor coils can be employed to design the rotor. One design will be a straight right-angled triangular coil without the right-angled extension. Where the final voltage generated will be the sum of vertical side and the base of the triangle minus the voltage generated by the hypotenuse side of the coil. Second configuration in generator action will be coil described in FIGS. 21, 21A and 21B. The voltage generated will be the voltage generated by side which is parallel to the shaft. Two other sides will mostly cancel each other because the voltage generated in the two sides will be in opposite direction. The final voltage will be the voltage generated by side B and the difference of voltage generated by sides R and L.

It will be observed that power output and power density available with the present invention is much higher than the prior art superconducting generators. These design concepts and fully cryogenic refrigeration will more than double the power density and thus power output of the generator of the same size available in prior art superconducting generators.

Construction and Assembly of Superconducting Dc Generator with Stator Coils with Right Angled Extension

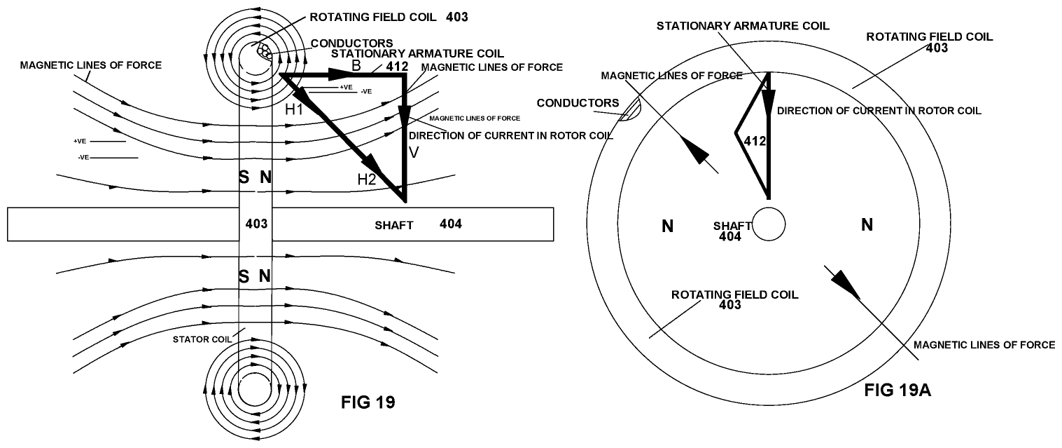

FIGS. 20 and 20A show the construction and integrated assembly of a superconducting DC generator with stationary armature coils 401 with right angled extension magnetically linking the rotating field coil 403 mounted on shaft 404.

The generator includes an armature (stator) assembly 414 and a field (rotor) assembly 415. The rotor assembly 415 is mounted on a rotating shaft 404 and the rotor assembly rotates as it magnetically links the armature assembly 414 by suitable airgaps depending on the design of field coil 403 and armature coil 401. The magnetic field produced by one pole of the field coil 403 is returned to the other pole by flux return path 417. The armature assembly is supported by armature supports 418. Both the armature 415 and field 415 assemblies are mounted inside a motor housing 419. The rotating shaft 404 is located on the housing by two bearings 420 as shown in FIGS. 20 and 20A. A vacuum jacket 421 with extra insulation creates a structure within the housing 419. The superconducting armature assembly 414 and field assembly 415 are mounted inside this structure. This structure is defined as low temperature cryostat 422. The function of the cryostat 422 is to maintain superconducting temperatures for the armature coils 401 and field coil 403 to maintain superconducting properties to conduct superconducting currents and maintain flux. Both the armature coils 401 and field coil 403 are preferably wound with HTS 2G superconducting wires. This may allow motor operation below 77K.

Installed on the shaft 404 is also a brushless exciter unit (BEU) 423. The BEU has a rotating armature and a stationary field. The stationary field is mounted on the housing 419 and the rotating armature is mounted on the shaft 404. The schematic and operation of brushless exciter unit is described earlier in FIG. 18. DC excitation power is applied to the stationary field coil of the BEU 423 and electrical power is produced by the generator action. The output of the BEU armature is connected to the generator field coil 403. Since high air gap sheer stresses will be generated this will result in high mechanical forces on the rotor coils 403. It is therefore important to wind the rotor coils 403 in a high strength coil former made from high strength suitable material and impregnated with epoxy resins. The input to the rotating filed coil is DC.

A closed loop Cryogenic refrigeration system 424 as shown in FIGS. 20 and 20A is located outside the generator housing and is connected to the cryostat by refrigerant transfer tube 425A and return tube 425B as shown in FIGS. 20 and 20A. The cryogenic refrigeration system 424 conducts heat from the armature coils 401 and the field coil 403 to the cryogenic refrigeration system 424, where the heat is dissipated. Cryogenic refrigeration system 424 maintains superconducting temperatures inside the cryostat 422 by circulating cryogenic refrigerant at superconducting temperatures. This keeps the field coil 403 and armature coils 401 in the superconducting state.

The field coil 403 is connected to the shaft 404 by means of torque tube 426 and the outer surface of the torque tube also forms the support structures for the field coil 403. The function of torque tube 426 is to transfer the torque provided by the generator drive shaft 404 to the field coil 403. The torque tube 426 also acts as a heat shield between the cryostat and the shaft 404 exposed to outside warm temperatures. This reduces the thermal load on cryogenic refrigeration system. The separate sections of the shaft 404 where coil is not mounted contains torque tube extensions 426A which also insulates cryostat from the sections of shaft 426 exposed to warm temperatures.

An electromagnetic shield 427 is fabricated around the field coil assembly 415 and is attached to vacuum jacket 421. The armature assembly 414 is secured to the housing 419 by stator supports 418.

Under the description of operating principles for rotor coils 115 perpendiculars to the stator coil 114 is described in detail how different electromagnetic mechanisms generate the required torque for the rotor coils 115.

### Special Coils for Brushless Commutatorless Dc Motor and Generators

FIGS. 21, 21A and 21B show embodiments of coils that have not been described earlier for both the motors and generators. FIG. 21 shows a coil where the coil side B is parallel to the shaft and the coil is vertical to the stator. In this coil the flux from the stator will interact with all the three sides and the final torque for motor and voltage for the generators will be determined by the Flemings left and right hand rules for motor and generator.

FIGS. 21A and 21B show the embodiment where the coil side B is parallel to the shaft and sides L and R are of unequal lengths. Unequal length will also allow voltage generated by sides L and R to be controlled. This will allow the resultant voltage to be selected at the desired value. This will also allow the coil sides L and R to be of smaller lengths and thus decreasing the total length of superconducting wires and positioned at a higher distance from the shaft than the coils described in FIGS. 2A, 2B and 2C.

It is possible to design many different configurations of the coils that can be employed in the motors and generators according to this invention. Important principle to be remembered in the design is that sides that that generate torque for the motor and voltage for the generator should produce the required result by neutralizing the effect of the sides that produce opposite result.

### Armature Reaction in Dc Motors and Generators

The effect of armature reaction in motors and generators is to weaken and distort main field due to magnetic field produced by the armature currents. The major effect of armature reaction is on the commutation. Since there is no commutation in the commutatorless motors and generators of the new invention no detrimental effect is produced on the operation of DC machines. By adding extra ampere turns on the main filed the effect is largely reduced.

### Detailed Description of Iron Core Brushless Communtatorless DC Motor

CONVENTIONAL COPPER WOUND MOTOR: An iron core copper wound brushless communtatorless motor according to the present invention offers advantages in terms of increased power density, superior performance and lower cost not achievable with existing DC machines with iron core and copper wound armature and field coils. Since there are not frequency dependent iron losses no laminations are required in the iron core.

In one embodiment of the motor a permanent magnet stator or stationary field is used with a triangular or multisided armature coil with a copper armature winding mounted on a rotating shaft.

### Operating Principles of Permanent Magnet Stator Iron Core Armature Brushless Commutatorless Dc Motor

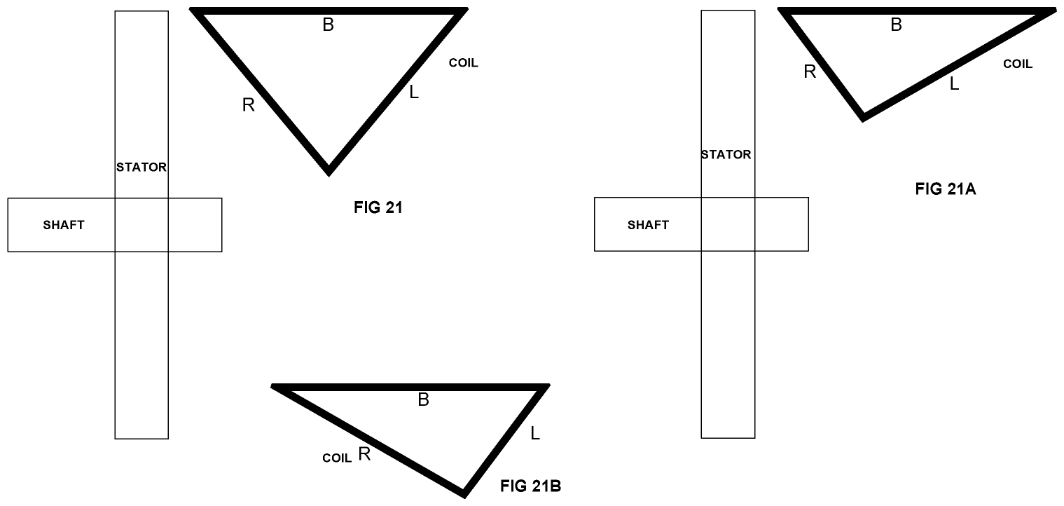

FIG. 22 shows a triangular coil with wires of coil sides L and R divided in the middle of the coil sides and separated as shown in FIG. 22. This coil will be defined as a bifurcated coil. The purpose of this special coil configuration is to allow only the coil side B to produce torque for the motor. A stationary disc type permanent magnet field will be used to demonstrate the principle of operation.

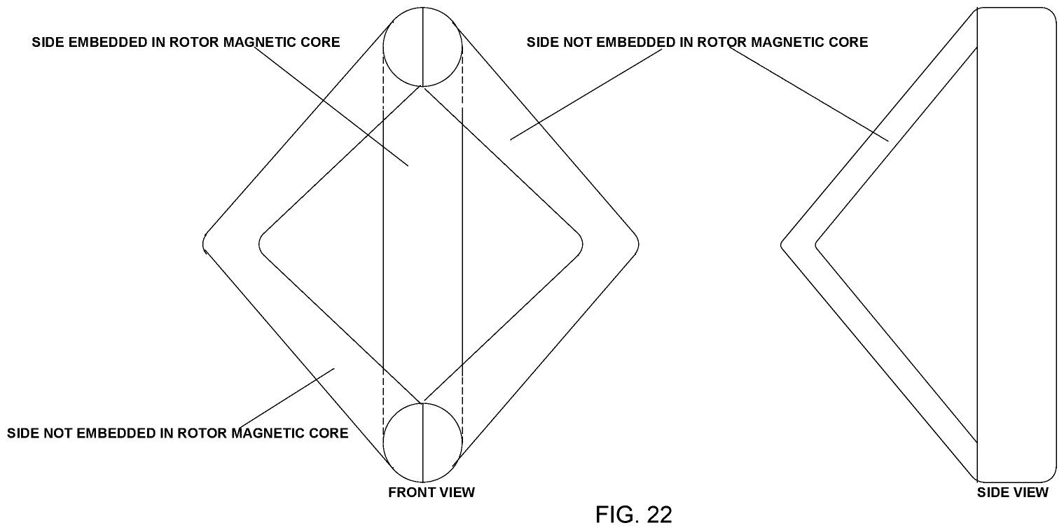

The bifurcated coil is used in the rotating armature. The armature coil is provided with a magnetic core made up of a flux conducting material as shown in FIG. 23 and rotates with the coil. One coil is provided as shown in FIG. 23. The purpose of the armature magnetic core is to receive magnetic flux from the stator pole of a selected polarity through an air gap and distribute the flux received form the selected pole to the pole of the opposite polarity of the stator thru two more airgaps to complete the magnetic circuit.

A magnetic core is also provided on the stator to transfer flux from one coil through two airgaps to the coil located on the other side of the permanent magnet as shown in FIG. 23.

This arrangement of the stator poles and rotor coils will produce torque in the same direction by all the coils of the motor armature as the armature rotates.

As shown in FIG. 23 the motor consists of a disc type permanent magnet stator 502. A shaft 503 passes through the inner opening of the stator magnet 502. A Triangular coil 501 is provided on each side of the stator 503 and mounted on the rotating shaft 503 as shown in FIG. 23. The coils 501 are each provided with magnetic core 504 as shown in FIG. 23. Two magnetic cores 505 and 505A are also provided on the stator 502. Stator core 505 is provided above the stator 502 and core 505A is provided in the inner opening of the stator magnet 502 as shown in FIG. 23. Alternately a core can also be provided on the rotor shaft which links the armature magnetic core 504. The function of the armature magnetic core 504 and the stator magnetic cores 505 and 505A is to allow flux from one pole of the motor to the opposite pole of the motor. Air gaps 504A and 504B are provided on each side of the stator 502 to allow flux from the stator north pole to propagate to armature core 504 as shown in FIG. 23. Flux originating from North Pole of the stator is propagated to the magnetic core 504 by an air gap 504A. After that the magnetic flux from the magnetic core 504 of the rotating coil 501 on one side is propagated to the stationary stator magnetic core 505 by an air gap 506 as shown in FIG. 23. The magnetic path is complete when the Flux from magnetic core 505 is transferred to the armature core on the South Pole side of the stator by an airgap 506B.

In a similar manner flux transfer takes place from the North Pole side of the stator to the south side of the stator by airgap 504A to 504 to airgap 507, 507A to stator core to airgap 504B to the South Pole side of the stator.

When the armature coils 501 are provided with DC current the following actions take place. Flux enters from the North Pole to armature core 504. As shown in FIG. 23, the side B of the coil has current as shown going vertically from the shaft to the stator core side. The flux from the stator north pole to armature propagates horizontal to the shaft. This will allow the current in the side B to interact with the flux at a perpendicular disposition.

Applying Fleming's left hand rule of motor action and looking from the right to left of this page towards the center of the shaft and when the vertical current in coil interacts with the horizontal flux from the North Pole the coil will experience torque in a clockwise direction.

In a similar manner Applying Fleming's left hand rule of motor action and looking from the right to left of this page towards the center of the shaft and when the vertical current in coil interacts with the horizontal flux going to the South Pole side of the stator the coil will also experience torque in a clockwise direction.

It is important to understand that there are no frequency dependent iron losses in this motor architecture. This will reduce the heat produced and increase the efficiency of the motor. The copper losses are also reduced due to smaller coils. The power density is further reduced since the armature conductors are active during 360 degrees of rotation. This will produce DC motor action with characteristics of permanent magnet DC motor.

### Construction and Assembly of Permanent Magnet Stator Iron Core Armature Brushless Commutatorless DC Motor

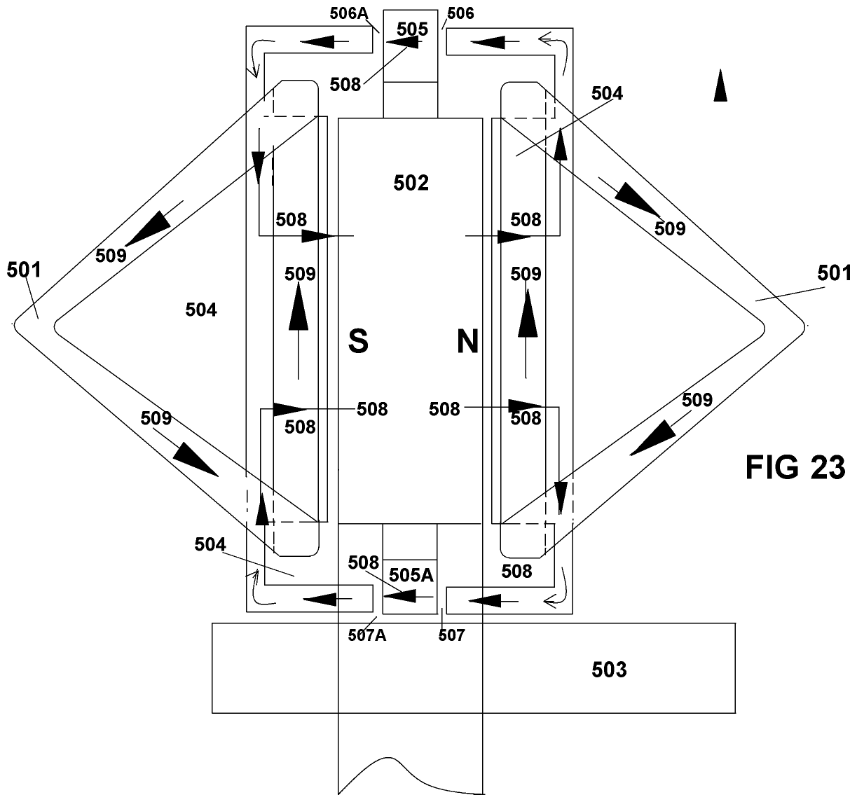

FIGS. 24 and 24A show the construction and integrated assembly of an iron core armature, permanent magnet motor with bifurcated armature coils perpendicular to the stator.

The motor includes a stator assembly 510 and an armature (rotor) assembly 513. The rotor assembly 513 is mounted on a rotating shaft 503 and the rotor assembly rotates as it magnetically links the stator assembly 510 by airgaps 506, 506A, 507, 507A. The magnetic field produced by one pole of the stator is returned to the other pole by flux return path as shown in FIG. 23. The stator assembly is supported by stator supports 512. Both the stator and rotor assemblies are mounted inside a motor housing 513. The rotating shaft 503 is located on the housing by two bearings 514 as shown in FIGS. 24 and 24A.

Installed on the shaft 503 is also a rotor power unit (RPU) 515. The RPU 515 has a rotating member and a stationary member. The stationary member is mounted on the housing 513 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for rotor coils 501 perpendiculars to the permanent magnet stator as shown in FIGS. 23 and 23A is described in detail how different electromagnetic mechanisms generate the required torque for the rotor coils 501.

For the permanent magnet motor operation to take place the rotor coils 501 have to be connected to the RPU and provided with power from PSS. The rotor coils 501 are to be provided with power from the RPU 515 by one of 6 RPU 515 design configurations. The electrical motor with rotor coils 501 perpendicular to the stator 503 will operate with operational characteristics and various performance parameters determined by the characteristics provided by permanent magnet stator with wound coil configuration.

STARTING AND SPEED CONTROL OF DC MOTOR: With the motor provided with a permanent magnet stator 502 and the rotor coils 501 properly connected in a selected configuration and suppled with power per FIGS. 9 thru 17 following actions take place. Since there is no back emf produced in the rotor coils 115 a large starting current will be generated depending upon the design parameters of the motor. This current will be limited to safe limit by a dedicated circuit in the PSS and motor will be allowed to start and will produce stating torque depending on the motor design parameters. Once the motor starts the speed control is achieved by controlling the armature voltage by PSS. The starting and speed control characteristics of the motor are superior to any existing permanent magnet motor.

### Construction and Assembly of Wound Stator, Iron Core Armature Brushless Commutatorless DC Motor

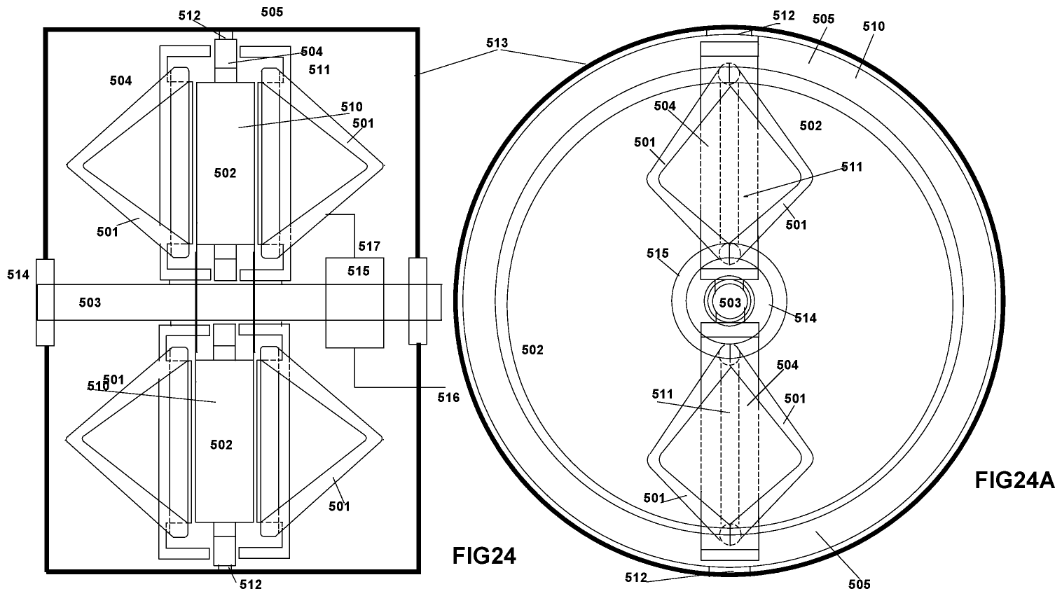

FIGS. 25 and 25A show the construction and integrated assembly of an iron core armature, wound stator motor with bifurcated armature coils perpendicular to the stator.

The motor includes a wound stator assembly 510 and an armature (rotor) assembly 511. The rotor assembly 511 is mounted on a rotating shaft 503 and the rotor assembly rotates as it magnetically links the stator assembly 510 by airgaps 506, 506A. In wound stator configuration stator core 505A and airgaps 507 and 507A are eliminated since there is no flux moving in that direction.

The magnetic field produced by one pole of the stator is returned to the other pole by flux return path as shown in FIG. 23. The stator assembly is supported by stator supports 512. Both the stator and rotor assemblies are mounted inside a motor housing 51. The rotating shaft 503 is located on the housing by two bearings 514 as shown in FIGS. 25 and 254A.

Installed on the shaft 503 is also a rotor power unit (RPU) 515. The RPU 515 has a rotating member and a stationary member. The stationary member is mounted on the housing 513 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for rotor coils 501 perpendiculars to the stator 502 as shown in FIG. 23 is described in detail how different electromagnetic mechanisms generate the required torque for the rotor coils 501. In wound stator configuration stator core 505A and airgaps 507 and 507A are eliminated since there is no flux moving in that direction.

### Operating Principles of Cylindrical Permanent Magnet Stator, Iron Core Armature Brushless Commutatorless DC Motor

FIG. 22 shows a triangular coil with wires of coil sides L and R divided in the middle of the coil sides and separated as shown in FIG. 22. This coil will be defined as a bifurcated coil. The purpose of this special coil configuration is to allow only the coil side B to produce torque for the motor. A stationary cylindrical type permanent magnet field will be used to demonstrate the principle of operation.

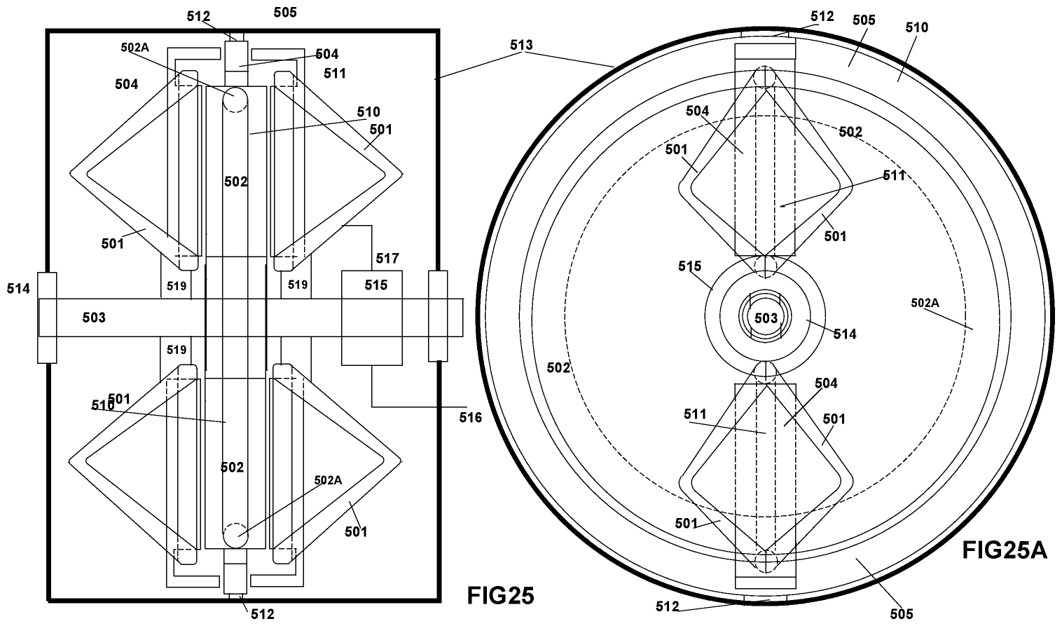

The bifurcated coil is used in the rotating armature. The armature coil is provided with a magnetic core made up of a flux conducting material as shown in FIG. 26 and rotates with the coil. One coil on each side is provided as shown in FIG. 26. The purpose of the armature magnetic core 504 is to receive magnetic flux from the stator pole N of a selected polarity through an air gap 504A and distribute the flux received form the selected N pole to the pole of the opposite polarity S of the stator thru airgap 504B to complete the magnetic circuit. The function of the armature coil magnetic core 504 is to allow flux from one pole of the motor to propagate to the opposite pole of the motor. Magnetic flux from the magnetic core 504 of the rotating coils is propagated to the pole of opposite polarity by an airgaps 504A and 504B as shown in FIGS. 26 and 26A. Two extensions of the armature core defined as armature core return paths 504C and 504D are formed in such a manner that it does not have direct contact with the stator magnet 502 as shown in FIGS. 26 and 26A. This extension 504C and 504D rotates as the armature rotates and links the opposite pole through an air gap 504B as shown in FIGS. 26 and 26A. The flux from the stator is first transferred to the armature core through the airgap 504A and the flux then passes through the extension of the armature core 504C and 504D to the second airgap 504B as shown in figure. From the airgap 504B the flux is transferred to the opposite pole. With these multiple paths the flux is transferred to the opposite pole thus completing the magnetic circuit. It will be observed and noted that by employing the multiple flux paths a complete magnetic circuit is formed offering the magnetic path of least resistance and providing the flux linkage with the conductors of armature coil 501.

This arrangement of the cylindrical stator poles and rotor coils will produce torque in the same direction by all the coils of the motor armature as the armature rotates.

As shown in FIGS. 26 and 26A the motor consists of a cylindrical type permanent magnet stator 502. A shaft 503 passes through the cylindrical stator magnet 502. A Triangular coil 501 is provided on each side of the rotor 511 and mounted on the rotating shaft 503 as shown in FIG. 26. The coils 501 are each provided with magnetic core 504 as shown in FIG. 26. The function of the armature magnetic core 504 and the armature core return paths 504C and 504D is to allow flux from one pole of the motor to the opposite pole of the motor. Air gap 504A is provided between armature 501 and the stator 502 to allow flux from the stator north pole to propagate to armature core 504 as shown in FIG. 26. Flux originating from North Pole of the stator is propagated to the magnetic core 504 by an air gap 504A. After that the magnetic flux from the magnetic core 504 of the rotating coil 501 is propagated to the stationary stator by armature flux return core 504C and 504D and airgap 504B as shown in FIG. 26.

The magnetic path is complete when the Flux from armature flux returns cores 504C and 504D is transferred to the South Pole side of the stator by an airgap 504B.

When the armature coils 501 are provided with DC current the following actions take place. Flux enters from the North Pole to armature core 504. As shown in FIG. 26, the side B of the coil has current 509 as shown going horizontally from the right to left of the shaft as shown in FIGS. 26 and 26A. The flux 508 from the stator north pole to armature propagates vertical to the shaft. This will allow the current in the side B to interact with the flux at a perpendicular disposition.

Applying Fleming's left hand rule of motor action and looking from the right to left of this page towards the center of the shaft and when the horizontal current 509 in coil interacts with the vertical flux 508 from the North Pole the coil will experience torque in anticlockwise direction.

It is important to understand that there are no frequency dependent iron losses in this motor architecture. This will reduce the heat produced and increase the efficiency of the motor. The copper losses are also reduced due to smaller coils. The power density is further reduced since the armature conductors are active during 360 degrees of rotation.

### Construction and Assembly of Cylindrical Permanent Magnet Stator, Iron Core Armature Brushless Commutatorless DC Motor

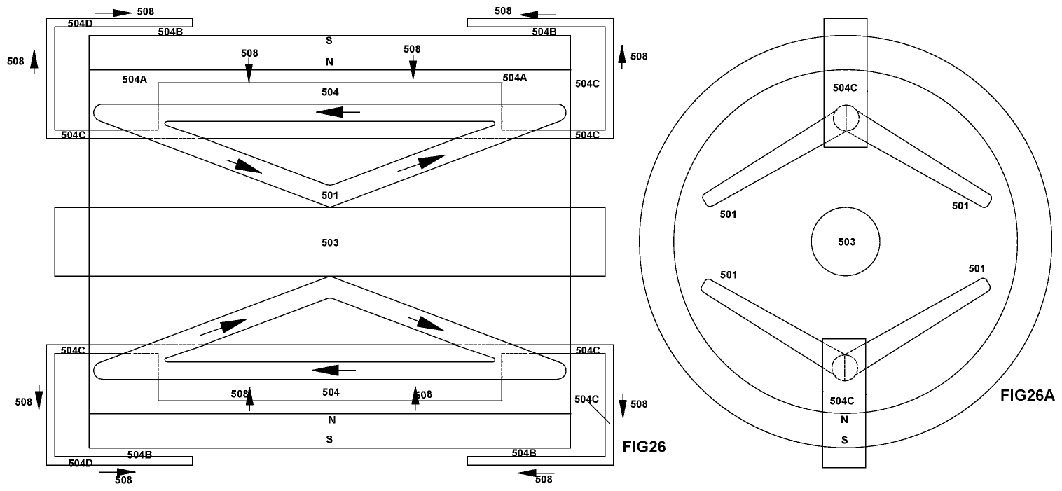

FIGS. 27 and 27A shows the construction and integrated assembly of an iron core armature, cylindrical permanent magnet motor with bifurcated armature coils where shaft is parallel to the cylindrical stator.

The motor includes a stator assembly 510 and an armature (rotor) assembly 511. The rotor assembly 511 is mounted on a rotating shaft 506 and the rotor assembly rotates as it magnetically links the stator assembly 510 by airgaps 504A and 504B. The magnetic field produced by one pole of the stator is returned to the other pole by flux return path as shown in FIG. 26. Referring to FIGS. 27 and 27A the flux from the North Pole is propagated to the South Pole by armature core 504 and flux return path 504C on one side and 504D on the other side. It will be observed that the stator is surrounded by armature magnetic paths formed by 504C and 504D. The stator and the armature assemblies cannot be assembled with flux return paths 504C and 504D because the flux return paths will obstruct the armature to be inserted in the stator opening. To avoid this and facilitate the assembly the flux return path 504C is divided into 2 sections by a joint 504C1. And the top section of 504C is not included in the first step of assembly. In the first step the armature is positioned with bearing on one side and without top section of 504C. Only after the armature is inserted the joint 504C1 assembles the top section of 504C to complete the magnetic path. The stator assembly is supported by stator supports 512. Both the stator and rotor assemblies are mounted inside a motor housing 513. The rotating shaft 503 is located on the housing by two bearings 514 as shown in FIGS. 27 and 27A.

Installed on the shaft 503 is also a rotor power unit (RPU) 515. The RPU 515 has a rotating member and a stationary member. The stationary member is mounted on the housing 511 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for permanent magnet cylindrical stator 502 with rotor coils 501 and shaft parallel to the cylindrical stator 502 as shown in FIGS. 26 and 26A is described in detail how different electromagnetic mechanisms generate the required torque for the rotor coils 501.

For the permanent magnet motor operation to take place the rotor coils 501 have to be connected to the RPU and provided with power from PSS. The rotor coils 501 are to be provided with power from the RPU 515 by one of 6 RPU 515 design configurations. The electrical motor with rotor coils 501 and shaft parallel to the cylindrical stator 502 will operate with operational characteristics and various performance parameters determined by the characteristics provided by permanent magnet stator with wound coil configuration.

STARTING AND SPEED CONTROL OF DC MOTOR: With the motor provided with a permanent magnet stator 502 and the rotor coils 501 properly connected in a selected configuration and suppled with power per FIGS. 9 thru 17 following actions take place. Since there is no back emf produced in the rotor coils 115 a large starting current will be generated depending upon the design parameters of the motor. This current will be limited to safe limit by a dedicated circuit in the PSS and motor will be allowed to start and will produce stating torque depending on the motor design parameters. Once the motor starts the speed control is achieved by controlling the armature voltage by PSS. The starting and speed control characteristics of the motor are superior to any existing permanent magnet motor.

### Construction and Assembly of Cylindrical Wound Stator, Iron Core Armature Brushless Commutatorless DC Motor

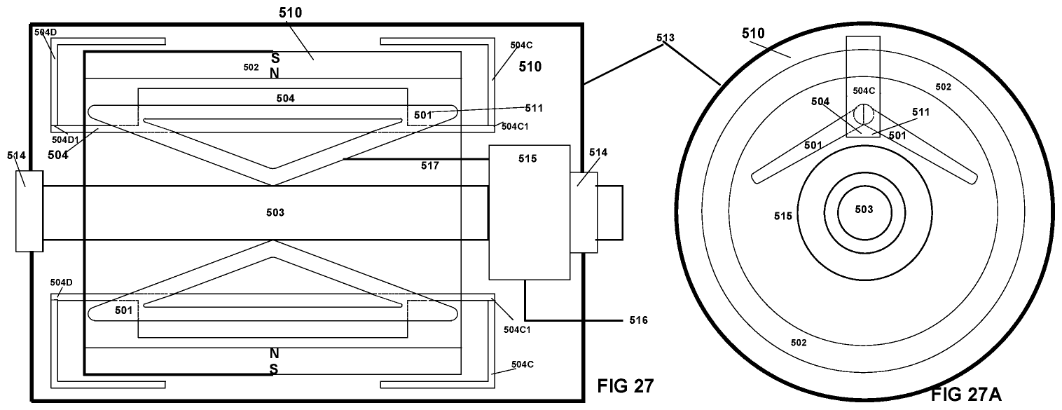

FIGS. 28 and 28A shows the construction and integrated assembly of an iron core armature, cylindrical wound stator motor with bifurcated armature coils perpendicular to the stator.

The motor includes a wound stator assembly 510 and an armature (rotor) assembly 511. The rotor assembly 511 is mounted on a rotating shaft 503 and the rotor assembly rotates as it magnetically links the stator assembly 510 by airgaps 504A and 504B.

The magnetic field produced by one pole of the stator is returned to the other pole by flux return path as shown in FIGS. 26 and 26A. The stator assembly is supported by stator supports 512. Both the stator and rotor assemblies are mounted inside a motor housing 511. The rotating shaft 503 is located on the housing by two bearings 514 as shown in FIGS. 28 and 28A.

Installed on the shaft 503 is also a rotor power unit (RPU) 515. The RPU 515 has a rotating member and a stationary member. The stationary member is mounted on the housing 511 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for cylindrical stator 502 and armature with magnetic core 504 and shaft parallel to the cylindrical stator 502 as shown in FIGS. 26 and 26A is described in detail how different electromagnetic mechanisms generate the required torque for the rotor coils 501. In wound stator configuration the stator 502 is magnetized by a stator coil 502A as shown in FIGS. 28 and 28A.

For the motor operation to take place the rotor coils 501 has to be connected to the stator coil 502 and the stator coil 502 is to be provided with power from PSS and rotor coils 501 is to be provided with power from the RPU 515 by one of 6 RPU 515 design configurations except the ones that use superconducting windings as described in the description CONNECTION SCHEMES FOR STATOR AND ROTOR FOR OPERATION OF SUPERCONDUCTING DC MOTOR and FIGS. 9 through 17. Since there are no superconducting windings in this configuration of stator and rotor the connection and parts using superconducting windings are excluded. In addition, FIGS. 9 through 17 also further describes 5 primary connection configurations by which rotor coils 501 are connected to stator coil 502. The electrical motor with rotor coils 501 perpendicular to the stator coil 502 will operate with operational characteristics and various performance parameters determined by connection between the stator coil 502 and rotor coils 501 by 5 major connection configurations described earlier. This enables the DC motor to obtain different operational characteristics.

STARTING AND SPEED CONTROL OF DC MOTOR: when stator coil 502 and rotor coils 501 are properly connected in a selected configuration and suppled with power per FIGS. 9 through 17 following actions take place. Since there is no back emf produced in the rotor coils 501 a large starting current will be generated depending upon the design parameters of the motor. This current will be limited to safe limit by a dedicated circuit in the PSS and motor will be allowed to start and will produce stating torque depending on the motor design parameters and connection configuration. Once the motor starts the speed control is achieved by methods described in FIGS. 9 through 17. The starting and speed control characteristics of the motor are superior to any existing wound stator motor.

Operating Principles of Superconducting Linear DC Motor with Armature Coils Parallel to the Stator Coil

Superconducting linear motors are not currently used in any major industry. With the high flux densities and current densities available for linear motors according to the novel principles of the present application it is possible to achieve performance not available in any prior art linear motors.

An important aspect of the new superconducting linear motors is to offer alternate power and force production mechanisms for high operating force requirement applications. This application is achieved as a replacement for hydraulic systems without the complications, cost and maintenance intensive operation of current hydraulic systems. Operating forces of 10,000 tons or more can be effectively developed by linear superconducting motor according to the present invention.

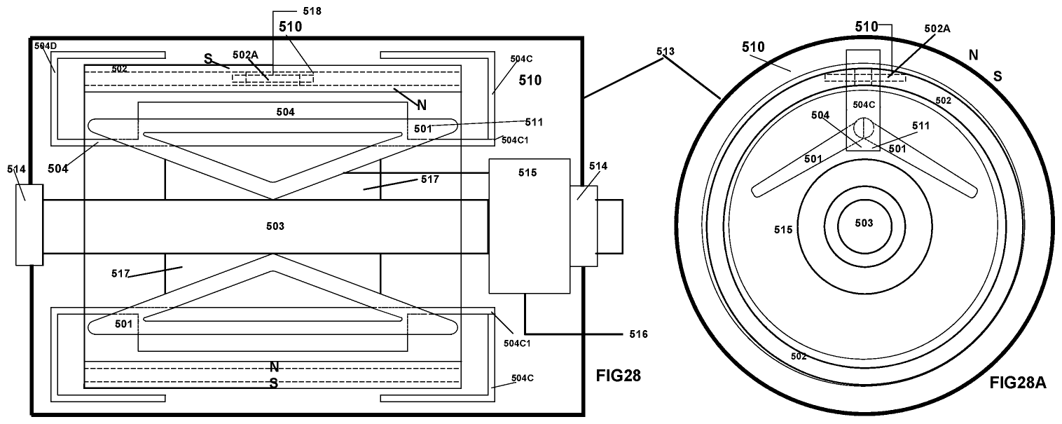

FIGS. 29 and 29A shows operating principles of linear motors. A rectangular stator coil 601 is shown with magnetic field produced by this coil. Top of the coil has North Pole and bottom of the coil has South Pole. A linear armature is provided with a triangular coil 602 mounted horizontal with the stator coil 601. The current 603 flowing in coil side B is perpendicular to the magnetic lines of force generated by the stator coil 601. The direction of current 603 in coil 602 is as shown in FIGS. 29 and 29A. DC power 605 is provided to both the stator coil 601 and the armature coils 602.

The direction of flux in the stator coil is from the coil going upwards from the North Pole and then to the South Pole. The direction of current 603 in coil side B is from the bottom to the top of this page as shown in FIGS. 29 and 29A. This disposes the current flowing in coil side B perpendicular to the magnetic lines of force generated by the stator coil 601. Applying Fleming's left hand rule of motor action it will be observed that the direction of force 604 produced by the coil side B will be from the left to the right of this page. The direction of force produced by coil side R and L will be as shown in FIGS. 29 and 29A. The direction of the force produced by side R and L are in opposite direction and therefore they will cancel each other having negligible effect on the force produced by side B. Reversing the direction of current in coil or stator coil will reverse the direction of force generated by the coil.

Multiple coils can be mounted on the linear armature on both side of the stator to increase the thrust produced by the linear motor.

Operating Principles of Superconducting Linear DC Motor with Armature Coils Vertical to the Stator Coil

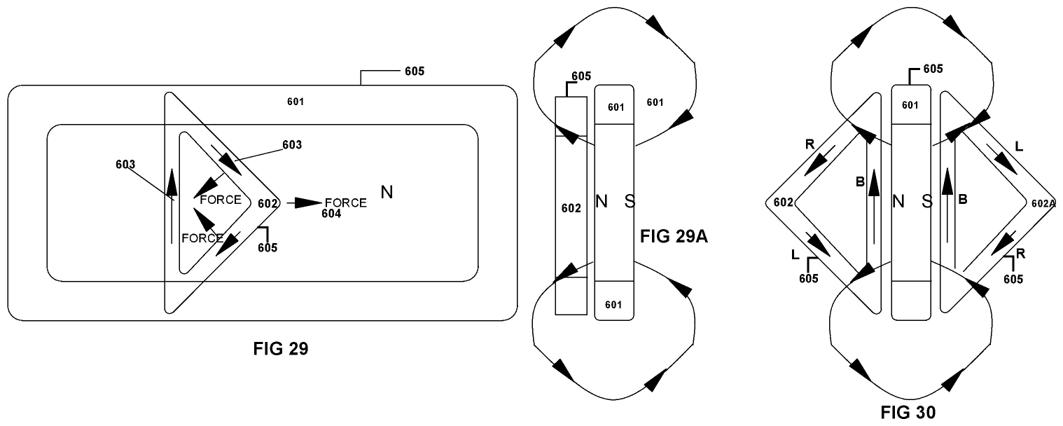

FIG. 30 shows an embodiment of a linear motor where the plane of the armature coils is perpendicular to the stator coil. A rectangular stator coil 601 is shown with magnetic field produced by this coil. Left side of the coil 601 has North Pole and right side of the coil has South Pole. A linear armature is provided with two triangular coils 602 and 602 mounted vertical with the stator coil 601. In this embodiment coils are provided on both the North Pole as well as south side of the stator coil 601 as shown in FIG. 30. The current flowing in coil sides B of 602 and 602A are perpendicular to the magnetic lines of force generated by the stator coil 601. The direction of current in coils 602 and 602A are as shown in FIG. 30.

Applying Fleming's left hand rule of motor action it will be observed that the direction of force 604 produced by the coil sides B of both the coils 602 and 602A will be from this page to the reader. The direction of force produced by coil side R and L will be determined by the Fleming's left hand rule of motor action. The direction of the force produced by side R of 602 and L of 602A are in opposite direction and therefore they will cancel each other. Similarly, the direction of the force produced by side L of 602 and R of 602A are in opposite direction and therefore they will cancel each other. This will have negligible effect on the force produced by sides B of coils 602 and 602A. DC power 605 is provided to both the stator coil 601 and the armature coils 602 and 602A. Reversing the direction of current in coil or stator coil will reverse the direction of force generated by the coil.

Construction and Assembly of Superconducting Linear DC Motor with Armature Coils Parallel to the Stator Coil

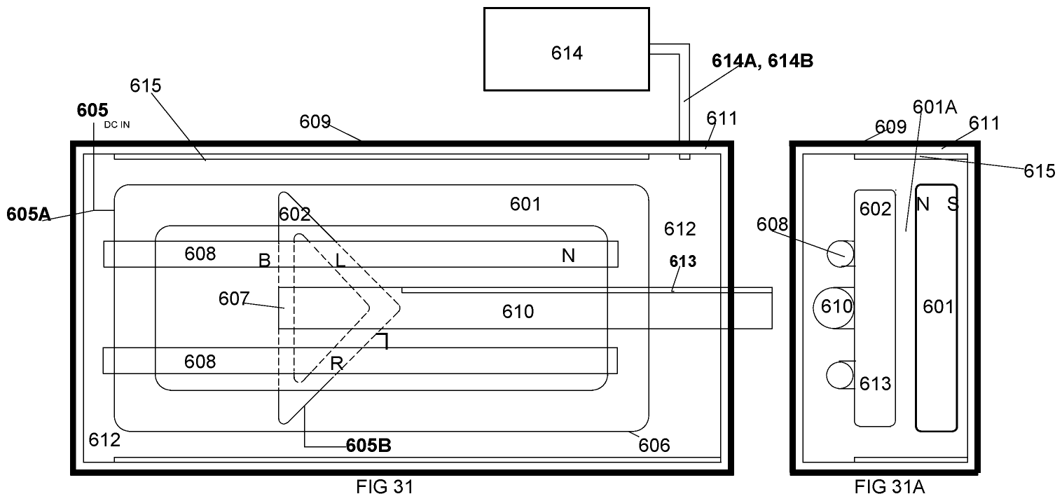

FIGS. 31 and 31A shows the construction and integrated assembly of a superconducting DC linear motor 600 with stationary stator coil 601 and armature coils 602 parallel to the stator coil 601. The DC linear motor includes a stator assembly 606 and an armature assembly 607. The armature assembly 607 is connected to a linear actuator and the armature assembly moves linearly on a linear bearing assembly 608 as it magnetically links the stator assembly 606 by airgap 601A. The linear bearing assembly should be insulated or capable of working in cryogenic temperatures. The magnetic field produced by one pole of the stator coil 601 is returned to the other pole to complete the magnetic path. Both the armature 607 and stator 606 assemblies are mounted inside a DC linear motor housing 609. A vacuum jacket 611 with extra insulation creates a structure within the housing 609. The superconducting armature assembly 607 and stator assembly 606 are mounted inside this structure. This structure is defined as low temperature cryostat 612. The function of the cryostat 612 is to maintain superconducting temperatures for the armature coils 602 and stator coil 601 to maintain superconducting properties to conduct superconducting currents and maintain flux. Both the armature coils 602 and stator coil 601 are preferably wound with HTS 2G superconducting wires. This will allow motor operation below 77K.

A closed loop Cryogenic refrigeration system 614 as shown in FIG. 31 is located outside the housing 609 and is connected to the cryostat by refrigerant transfer tube 614A and return tube 614B as shown in FIGS. 31 and 31A. The cryogenic refrigeration system 614 conducts heat from the armature coils 602 and the stator coil 601 to the cryogenic refrigeration system 614, where the heat is dissipated. Cryogenic refrigeration system 614 maintains superconducting temperatures inside the cryostat 612 by circulating cryogenic refrigerant at superconducting temperatures. This keeps the stator coil 601 and armature coils 602 in the superconducting state.

The armature assembly 607 is connected to the linear actuator 610 by a thermal barrier 613 and this also forms the support structures for the armature coil 602. The function of thermal barrier is to transfer the force provided by the armature coils to the linear actuator and it also acts as a heat shield between the cryostat 612 and the linear actuator exposed to outside warm temperatures. This reduces the thermal load on cryogenic refrigeration system. An electromagnetic shield 615 is fabricated around the stator assembly 606 and is attached to vacuum jacket 611. The stator assembly 606 is secured to the housing 609.

The linear motion generated by is created by interaction of magnetic field of the stator coil and current in the armature coil. Power 605 to the stator coil 601 is provided directly by 605A and armature is provided power 605B from a stationary brush and sliding electrode with linear motion mechanism (not shown) located on armature assembly 607. The sliding electrode collects power from a stationary brush and transfers it to armature coil 602. Alternated method to transfer power to the armature coils 602 will be to use linear transformer. Design and construction of linear transformer is known in prior art.

Under the description of operating principles for armature coils 602 horizontal to the stator coil 601 is described in detail how different electromagnetic mechanisms generate the required linear force for the armature coils 602.

Principles of Operation and Construction and Assembly of Iron Core Linear DC Motor with Armature Coils Perpendicular to the Stator Coil

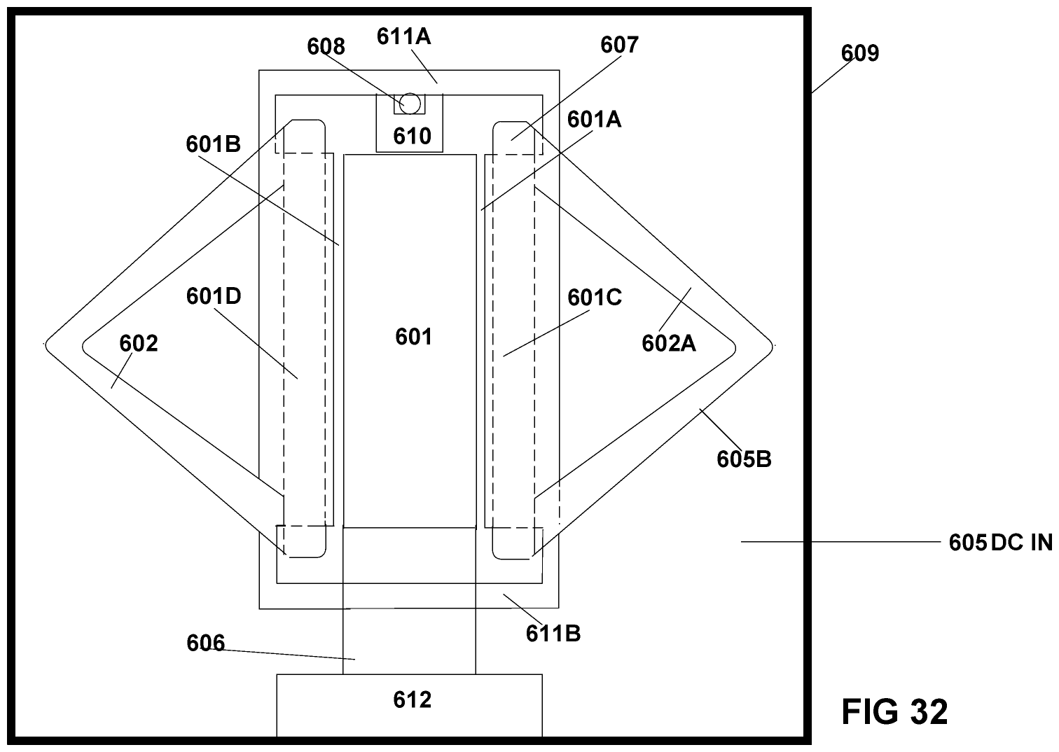

FIG. 32 shows the construction and integrated assembly of an iron core armature, permanent magnet stator linear motor with triangular armature coils perpendicular to the stator.

The linear motor includes a permanent magnet stator assembly 606 and an armature assembly 607. The stator assembly includes permanent magnet 601PM. The armature assembly 607 includes two armature coils 602 and 602A and is mounted on a linear bearing assembly 608 as it magnetically links the stator assembly 606 by airgaps 601A and 601B. The sides B of the armature coils 602 and 602A are enclosed inside magnetic cores 601C and 601D. This will allow the magnetic flux from stator to only link side B of the armature coils and return the flux to the opposite pole by flux return paths described in the description that follows. The magnetic flux from stator will not link sides L and R of the armature coils. This will enable only the side B of the armature coils to produce linear force.

The magnetic field produced by one pole of the stator 601 is returned to the other pole by flux return paths 611A and 611B as shown in FIG. 32. The stator assembly is supported by stator supports 612. Both the stator and armature assemblies are mounted inside a motor housing 609. A linear actuator 610 which transfers the operating force from the armature coil 602 and the armature assembly 607 to the required point of use is connected to the armature assembly 607.

The linear motion generated by is created by interaction of magnetic field of the stator and current in the armature coil. DC Power 605 to the armature is provided by 605B from a stationary brush and sliding electrode with linear motion mechanism (not shown) located on armature assembly 607. The sliding electrode collects power from a stationary brush and transfers it to armature coils 602 and 602B. Alternated method to transfer power to the armature coils 602 will be to use linear transformer. Design and construction of linear transformer is known in prior art.

It is also possible to produce linear motor action by only one armature coil perpendicular to the field coil as shown in FIG. 30. Only one coil 602A will be used and the coil 602A will be moved 180 degrees so that the apex of the triangle formed by sides R and L will be closer to the field coil and the side B will be on the other side at a greater distance from the field coil and parallel to the field coil. According to the Flemings left hand rule of motor action the linear force generated by the coil sides L and R will be in the opposite direction and will cancel each other. The linear force generated by the armature coil will be the force generated by the coil side B.

Another method of generating linear force will be identical to motor action created by two field coils as shown in FIGS. 34 and 34A. The two opposing stationary linear field coils with like polarity will be mounted on housing and an armature coil will magnetically link the two coils and linear force will be produced according to the Flemings left hand rule of motor action in similar manner described.

The present application should be understood by one skilled in the art as covering all embodiments of the motor both with superconducting windings as well as conventional copper windings.

It should be appreciated that features considered unique to the present application include DC motor performance superior to other prior art motors in many respects primarily in terms of higher torque and ease of speed control. Further, communtators and brushes contribute to higher costs for DC motors. The present application eliminates the need for commutators and brushes. In DC operation it offers better performance at lower cost by eliminating the need for commutation.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A superconducting brushless commutatorless DC electrical motor, comprising:
a machine housing;
a first stationary member having:
at least one field coil;
a field pole magnetic path mounted on the machine housing; and
a magnetic field;
a first rotating member having:
an armature magnetic path
at least one armature coil having a plurality of coil sides;
a second stationary member having:
a plurality of field system yoke magnetic flux conducting paths linking to the first stationary member;
a second rotating member having:
a plurality of armature yoke magnetic flux conducting paths linking to the first rotating member;
a shaft disposed along an axis around which the first rotating member rotates;
a power transfer device configured to transfer power to the first rotating member via a plurality of modes characterized by brushless power transfer including rotary power transfer device, liquid metal rotating contract, rotating transformers, brushes and slip rings;
a cooling assembly configured to cool the field coil and the armature coil simultaneously in a sealed cryostat at superconducting temperatures;
wherein, the first stationary member magnetically couples to the first rotating member and the second stationary member magnetically couples to the second rotating member and at least one coil of the first stationary member magnetically couples at least one armature coil of the first rotating member;
wherein, commutatorless operation is produced by the first stationary member producing a magnetic field in a pattern linking the plurality of coil sides of the first rotating member where at least one coil side produces main driving torque in a direction and a remainder of coil sides produce torque in a direction that cancels torques produced by the remainder of the coil sides which is a direction opposite the main driving torque preventing the remainder of the coil sides to produce torque in the direction opposite the main driving torque and producing continuous rotation;
wherein, a direct current power is applied to the field coil and the armature coil;
wherein, the magnetic field is produced by a permanent magnet.

2. The superconducting brushless commutatorless DC electrical motor of claim 1, wherein the first stationary member includes:
a field coil made from superconducting conductors;
a cooling assembly to cool the field coil at superconducting temperatures;
wherein the field coil is substantially circular shaped;
wherein the field coil is generally concentric with the shaft;
wherein the field coil is located between the at least two armature coils;
wherein the at least two armature coils are substantially triangular shaped;
wherein the at least two armature coils have a plurality of coil sides including vertical coil sides perpendicular to the axis of the shaft and parallel to the field coil;
wherein the armature coil sides form an angle to the shaft and a torque tube assembly transfers torque from the armature coils to the shaft and the cooling assembly simultaneously cooling the field coil and the armature coils at superconducting temperatures;
wherein a flux produced by the field coil travels along the shaft and interacts radially relative to the shaft with the vertical armature coil sides;
wherein a direct current power is applied to both the field coil and the at least two armature coils;
wherein the main driving torque is produced by the vertical coil sides of the at least two armature coils producing continuous rotation.

3. The superconducting brushless commutatorless DC electrical motor of claim 1, wherein the at least one armature coil has a plurality of coil sides and the plane of the at least one armature coil is parallel to the plane of the field coil;

4. The superconducting brushless commutatorless DC electrical motor of claim 1, wherein the at least one armature has two sides at a right angle to each other and a plurality of coil sides, one side is parallel to the shaft and the other side perpendicular to the shaft;

5. The superconducting brushless commutatorless DC electrical motor of claim 1, wherein the at least one armature coil has a plurality of coil sides including horizontal coil side parallel to the axis of the shaft and perpendicular to the field coil and rotates along the circumference of the field coil wherein the driving torque of the motor is produced by the coil side parallel to the shaft and perpendicular to the field coil since the torque produced by the remainder of the coil sides cancel each other;

6. The superconducting brushless commutatorless DC electrical motor of claim 1, wherein at least one substantially triangular shaped armature coil having a plurality of coil sides with one side parallel to an axis of the shaft and perpendicular to the two field coils and a remainder of armature coil sides form an angle to the shaft and the two field coils and a torque tube assembly transfers torque from the armature coil to the shaft and the cooling assembly simultaneously cools the two field coils and the armature coil at superconducting temperatures and the flux produced by the two field coils of like polarity travel in opposite directions along the shaft and radially in relation to the shaft interacts with a horizontal armature coil side in a same direction and flux from the two field coils of like polarity moving in a opposite direction simultaneously interacting with two armature coil sides forming angle to the shaft and carrying current in the opposite direction.

7. The superconducting brushless commutatorless DC electrical motor of claim 1, wherein the first stationary member includes a coil made from conventional copper conductors and a permanent magnet to produce a magnetic field.

8. The superconducting brushless commutatorless DC electrical motor of claim 1, wherein the second stationary member includes flux conducting iron core in a cylindrical form.

9. The superconducting brushless commutatorless DC electrical motor of claim 1, wherein the field coils of the first stationary member are connected with the armature coils of the first rotating member in modes to obtain different performance characteristics.

10. The superconducting brushless commutatorless DC electrical motor of claim 1, wherein the first rotating member includes an armature coil made from superconducting conductors and includes a torque tube assembly to transfer torque from the armature coil to the shaft.

11. The superconducting brushless commutatorless DC electrical motor of claim 1, wherein the first stationary member and first rotating member magnetically link by a magnetic iron core and an AC series motor connection configured to operate in AC series mode.

12. A superconducting brushless commutatorless DC electrical generator, comprising:
a machine housing;
a first rotating member including:
at least one field coil;
a field pole magnetic path; and
a magnetic field;
a first stationary member mount on the machine housing including:
an armature magnetic path; and
at least one armature coil;
a second rotating member including a plurality of field system yoke magnetic flux conducting paths linking to the first rotating member;
a second stationary member including a plurality of armature yoke magnetic flux conducting paths linking to the second stationary member;
a shaft mounted on the machine housing disposed along an axis around which the first rotating member rotates;
a brushless exciter including at least one brushless exciter armature coil connected to at least one field coil mounted on the shaft, wherein the brushless exciter armature coil magnetically links a stationary brushless exciter field coil when DC power is applied;
a power transfer device configured to transfer power to the first rotating member by a plurality of modes characterized by brushless power transfer including rotary power transfer device and brushes and slip rings;
wherein the first rotating member and the first stationary member are magnetically coupled to each other by the second rotating member and the second stationary member;
wherein the first rotating member produces a magnetic field in a pattern which links the plurality of coil sides of the first stationary member having coil sides generating electromotive force in different directions such that at least one selected coil side produces a main electromotive force in a selected polarity and direction and a remainder of the coil sides produce an electromotive force in a direction that cancels electromotive forces produced by the remainder of the coil sides in an opposite direction to the main electromotive force preventing the remainder of the coil sides from producing electromotive force in the opposite direction;
wherein the main electromotive force produces continuous ripple free electromotive force by commutatorless operation;
wherein an output voltage is able to circulate current in external circuit by commutatorless operation;
wherein a direct current field excitation is applied to the field coils producing DC operation; and
wherein the magnetic field generates a DC voltage.

13. The superconducting brushless commutatorless DC electrical generator of claim 12, wherein the first stationary member and the first rotating member are connected to each other and in additional mode the excitation source is connected separately to the field coil.

14. The superconducting brushless commutatorless DC electrical generator of claim 12, wherein the armature coil comprises a plurality of right angled extensions.

15. The superconducting brushless commutatorless DC electrical generator of claim 12, wherein the rotating field comprises at least two coils facing each other with like polarities and the stationary armature coil comprises a substantially triangular shaped coil located between two rotating coils.

16. A superconducting brushless commutatorless DC linear electrical motor, comprising:
a machine housing;
a first stationary member including:
at least one field coil;
a field pole magnetic path mounted on the machine housing; and
a magnetic field;
a first linear travel member including:
a linear armature magnetic path; and
at least one linear armature coil having a plurality of coil sides a second stationary member including a plurality of field system yoke magnetic flux conducting paths linking to the second stationary member;
a second linear travel member including a plurality of armature yoke magnetic flux conducting paths linking to the second linear travel member;
a linear actuator assembled along the second linear travel member and configured to transfer linear force to a load;
a power transfer device configured to transfer power to the first linear travel member by a plurality of modes characterized by brushless power transfer including a linear power transfer device having liquid metal linear contacts, linear transformers, linear brushes and sliding contacts;
a cooling assembly configured to cool the field coil and linear armature coil;
wherein the first stationary member and first linear travel member are magnetically coupled and the second stationary member and second linear travel member are magnetically coupled;
wherein the first stationary member produces a magnetic field in a pattern which links the plurality of coil sides of the at least one linear armature coil of the first linear travel member having coil sides carrying current in different directions such that at least one selected coil side produces a main linear force in a same direction and a remainder of the coil sides producing a linear force in a direction that cancels forces produced by the remainder of the coil sides in an opposite direction to the main linear force preventing the remainder of the coil sides from producing linear force in the opposite direction to the main linear force producing continuous linear force by commutatorless operation;
wherein a direct current power is applied to both the field coil and the armature coil;
wherein the magnetic field is produced by a permanent magnet.

17. The superconducting brushless commutatorless DC linear electrical motor of claim 16, wherein the linear armature coil is in a plane parallel to the field coil.

18. The superconducting brushless commutatorless DC linear electrical motor of claim 16, wherein a main driving linear force is produces continuous linear motion.

19. The superconducting brushless commutatorless DC linear electrical motor of claim 16, wherein the flux conducting paths are made from flux conducting iron core.

20. The superconducting brushless commutatorless DC linear electrical motor of claim 16, wherein the plane of the at least one armature coil is perpendicular to the field coil.
